(19) United States
(12) Patent Application Publication
(10) Pub. No.: US 2014/0342218 A1
(43) Pub. Date: Nov. 20, 2014

(54) Gravoltaic Cells

(71) Applicant: Douglas W. Houle, Clinton Township, MI (US)

(72) Inventor: Douglas W. Houle, Clinton Township, MI (US)

(21) Appl. No.: 13/986,536

(22) Filed: May 14, 2013

(51) Int. Cl. H01M 14/00

(52) U.S. Cl. CPC H01M 14/00
USPC 429/163; 29/623.1

(57) ABSTRACT

A gravoltaic cell converts a gravitational force into electrical energy. The cell includes a reaction vessel and a first stationary homogeneous phase of dissociated aqueous cations and a second stationary homogeneous aqueous phase of dissociated aqueous reactant cations, both phases being disposed within the reaction vessel, and providing bulk solvent and anions a stationary bulk volume of a homogeneous mixture of solvent and dissociated anions collectively disposed homogeneously throughout the two layers of dissociated aqueous cations. The cell also includes an anode junction providing electrochemically active dissimilar anode/cation species junction. The cell also includes a cathode junction providing a gravity-sustained electrochemically passive similar cathode/cation species junction. A buoyancy separation is gravitationally sustained between two distinct stationary homogeneous phases of dissociated aqueous cations differing chemically in species and differing physically in buoyancy disposed within a homogeneous stationary bulk mixture of solvent and dissociated anions disposed within the reaction vessel.

This application is related to and claims priority to U.S. Provisional Application No. 61/207,606 (Houle), entitled “Electrochemical Baro-Diffusion Cells” filed on Feb. 17, 2009; and U.S. Provisional Application No. 61/210,133 (Houle), entitled “More Electrochemical Baro-Diffusion Cells” filed on Mar. 16, 2009; U.S. patent application Ser. No. 12/658,562 (Houle), entitled “Gravoltaic Cell” filed on Feb. 11, 2010; and U.S. Provisional Application No. 61/689,835, entitled “Gravoltaic Cells” filed on Jun. 14, 2012.

### FIELD OF THE INVENTION

The present invention relates to electrochemical gravoltaic cells, and more particularly, to devices and methods for producing robust and long-lived electrochemical gravoltaic cells that convert a gravitational force into electrical energy.

### BACKGROUND OF THE INVENTION

Generating electrical energy by electrochemical means involves a potential difference or disparity between the electrochemical environments at the two electrodes of a cell; the produced electrical energy is the cell's way of equalizing said disparity. There are several types of disparities from which to choose, among them are:
1. Said disparity may be a disparity between the two dissimilar electrode species in contact with a single electrolytic species, such as the voltaic pile, Volta stacked several pairs of alternating copper (or silver) and zinc discs (electrodes) separated by cloth or cardboard soaked in brine or acid (electrolyte).
2. Said disparity may be a disparity between two dissimilar electrode species and two dissimilar electrolytic species, such as the Gravity or Daniell cell, wherein a zinc anode is in contact with a zinc sulfate electrolytic solution, and a copper cathode in contact with a copper sulfate electrolytic solution.
3. Said disparity may be a disparity between two similar electrodes each in contact with a different concentration of a single reactant electrolytic species, such a concentration cell. In some cases gravity may participate in the concentration disparity.
4. Said disparity may be a disparity between an anode phase of one species (such as but not limited to copper) and a dissimilar species cation phase (such as but not limited to calcium cations) in contact with said anode, such as the gravoltaic cell, wherein gravity, through positive buoyancy and negative buoyancy, sustains the species disparity.

Each of the above disparities is of a different type, each with its own unique description, characteristics, and performance. All disparities are not necessarily disparities of molar concentration. There are many possible disparities involving disparities of physical properties of matter. The physical properties of an object may include, but are not limited to, absorption (physical), absorption (electromagnetic), albedo (reflection coefficient), angular momentum, area, brittleness, boiling point, capacitance, color, concentration, density, dielectric, ductility, distribution, efficacy, elasticity, electric charge, electrical conductivity, electrical impedance, electric field, electric potential, emission, flow rate, fluidity, frequency, hardness, inductance, intrinsic impedance, intensity, irradiance, length, location, luminance, luminescence, luster, malleability, magnetic field, magnetic flux, mass, melting point, moment, momentum, opacity, permeability, permittivity, plasticity, pressure, radiance, solubility, specific heat, resistivity, reflectivity, refractive index, spin, strength, stiffness, temperature, tension, thermal conductivity, velocity, viscosity, phase, wave impedance, wherein a disparity in many of these physical properties may be utilized in some way to cause a disparity in the electrochemical environment across two electrodes to generate electrical energy. Additionally, gravity may be utilized to cause or assist in a physical property disparity.

For galvanic cells, it is desirable to have both 1) the largest possible electrochemical junction disparity between the anode phase of a first species and the compartmentalized homogeneous stationary phase of dissociated aqueous reactant cations of the second species in immediate contact with the surface of the anode phase of the first species and 2) the highest possible number of reactant cations of the second species in immediate contact with the surface of the anode phase of the first species. Meeting both these conditions provides the large electrochemical junction disparity needing to produce useful anode-reactant cation reactions that produce useful electromotive force, while at the same time provides a sufficiently high number of reactant cations to react with the anode phase to produce useful electrical current.

A concentration cell is a limited form of a galvanic cell that has two equivalent half-cells (or compartments) of the same aqueous reactant species differing only in concentrations, but not in species, in contact with two electrodes of the same species as the reactant species. A concentration cell is a limited source of electrical energy because it fails to provide any species disparity at the junction between the anode phase and the reactant cation phase in contact with the anode phase.

A concentration cell is a limited source of electrical energy because it fails to provide a high concentration of reactant cation species in contact with the anode phase, relative to the concentration of reactant cation species in contact with the cathode phase.

A concentration cell requires a concentration difference of 10 times or greater of the single reactant species to produce 30 millivolts (with luck) at room temperature, this is an unlikely event in a single container limited to gravitational and or magnetic forces.

In order to provide a good electrochemical junction disparity between the anode phase of one species and the similar reactant cation phase of the same species, the concentration of reactant cations must be very small, that is, a large concentration of one species within the anode phase and a small concentration of the same species within reactant phase, which in turn severely limits the number of chemical reactions occurring between the anode phase and the reactant phase at the interface between the anode phase and the reactant phase, and limits the total electrical current available to an external electrical load. On the other hand, in order to provide a good concentration of reactant cation species in contact with the anode phase, the concentration of reactant cations must be near saturation, which in turn severely limits the concentration disparity between the anode phase and the reactant cation phase, which in turn severely limits the junction potential or voltage available to an external electrical load. The concentration disparity has the inherent problem of having two limitations working at cross purposes.

A concentration cell produces a small voltage as it attempts to reach concentration equilibrium of the aqueous reactant. This equilibrium occurs when the concentration of a single reactant in both cells are equal. Because an order of magnitude concentration difference of the single reactant produces less than 30 millivolts at room temperature, concentration cells are not typically used for energy storage. Specifically, a concentration cell is a limited form of a galvanic cell because it utilizes an electrochemically passive similar anode/cation concentration junction disparity between an anode phase of the first species and a reactant cation phase of the first species.

THE GRAVITY CELL—The gravity cell such as U.S. Pat. No. 715,654 (Friend) has the disadvantages of:
a. an eroding zinc anode that requires periodic replacement from the outside world;
b. the eroding zinc anode causing a buildup of excess zinc sulfate solution within the cell that requires removal to the outside world; and
c. consumption of copper from the copper sulfate solution as copper is plated out onto the copper cathode, requiring the addition of more copper sulfate crystals from the outside world.
d. Buildup of plated copper onto the cathode requiring removal to the outside world.

U.S. Pat. No. 715,654 (Friend) has the further disadvantage of diminished output current per cross sectional area due to the use of a partition to keep the two electrolytic solutions separate. Said partition increases the internal cell resistance and therefore reduces the available electrical current per given cell. Gravottaic cells of the present invention do not utilize a partition.

The preferred embodiments of the present invention provide the advantages of:
a. Providing an electrochemically active species disparity between the anode phase of the first species and the reactant cation phase of the second species,
b. utilizing positive and negative buoyancy to sustain said electrochemically active species disparity between the anode phase of the first species and the reactant cation phase of the second species,
c. plating out the eroded and dissolved anode species onto the cathode, wherein the anode and the cathode may be interchanged thus eliminating the need to add new anode material to the system from the outside world, however, neither the cell body nor the cation phases are inverted,
d. plating out excess dissolved anode species onto the cathode at the same rate as anode material is being dissolved into solution at the anode resulting in a fixed amount of anode cations within the cell, thus eliminating the need to remove material from or add material to the outside world, and
e. maintaining a fixed amount cations within the cell, thus eliminating the need to remove material from or add material to the outside world world.
f. ability to interchange the two electrodes as mass is transferred from the anode to the cathode, thus eliminating the need to remove material from or add material to the outside world world.

There exists a need for practical and convenient cells for producing robust and long-lived electrochemical cells for generating electrical power and delivering said electrical power to an external workload. Several approaches have been proposed, but none have found commercial acceptance.

### SUMMARY OF THE INVENTION

The method of creating a gravoltaic cell of the present invention converts gravitational force into electrical energy. The method comprises:
1. Providing a driving disparity at the junction between a homogenous stationary anode phase of a first species and a homogenous stationary reactant cation phase of a second species in contact with the surface of the anode phase of the first species. The driving disparity is a species disparity between a stationary homogenous anode phase of a first species in contact with a stationary homogenous reactant cation phase of a second species, as opposed to the moving (from a high concentration to a low concentration) inhomogeneous molar concentration disparity of a single reactant species utilized by the typical concentration cell. A stationary homogenous anode phase of the first species and a stationary homogenous reactant cation phase of said second species are separate and in contact with each other wherein both stationary homogenous phases are in the same compartment of the same reaction vessel. Having two separate stationary homogenous phases, the anode phase and the reactant cation phase, in the same compartment of the reaction vessel is a highly non-random event and as a result, the two phases form a high potential energy junction. The system will attempt to lower the potential energy by dissolving the stationary homogenous anode phase into the stationary homogenous reactant cation phase within said compartment of said reaction vessel to form a uniform stationary homogenous phase throughout. At the surface of the stationary homogenous anode phase, atoms of the first species on the surface of the anode phase oxidize and dissolve into solution into the stationary homogenous reactant cation phase of the second species as liberated cations of said first species. The liberation of the cations of the first species has the effect of displacing the reactant cations of the second species in immediate contact with the surface of the anode phase of the first species away from the surface of the anode phase of the first species. Said displacement has the effect of pushing reactant cations of the second species that are in immediate contact with the surface of the anode phase of the first species away from the surface of the stationary homogenous anode phase of the first species. Said displacement causes said reactant cations of the second species to lose contact with the surface of the anode phase of the first species. Said displacement has the effect of reducing the junction species disparity at the junction between the anode phase of the first species and the reactant cation phase of the second species. Gravitational force, through the action of positive buoyancy and negative buoyancy causes a migration of said liberated cations of said first species through said compartmentalized homogeneous stationary dissociated aqueous reactant cations of the second species away from said anode phase of said first species. Said migration allows fresh reactant cations of the second species to reconnect with the anode phase of the first species and again contact the surface of the anode phase of the first species thus increasing the junction species disparity at the junction between the anode phase of the first species and the reactant cation phase of the second species. Thus through the combined actions of positive buoyancy and negative buoyancy said species disparity between the anode phase of the first species and the reactant cation phase of the second species is sustained.
2. Providing an electrochemically active anode junction-species disparity at a junction between a stationary homogenous anode phase of the first species and a stationary homogenous reactant cation species phase of a second species in immediate contact with the surface of the anode phase, comprising a stationary homogenous anode phase of said first species having a first placement and in contact with a first stationary homogeneous phase of dissociated aqueous reactant cations of the second cation species having a first placement. The first placement of the first stationary homogeneous phase of a reactant cation phase of a second species is maintained by gravity by either negative buoyancy or positive buoyancy.

The first placement of the stationary homogeneous phase of a reactant cation species phase of a second species occupies an upper compartment of the reaction vessel for negative buoyancy, and the first placement of the stationary homogeneous phase of a reactant cation species phase of a second species occupies the lower compartment of the reaction vessel for the positive buoyancy.

For a more complete understanding of the galvoltaic cells of the present invention, reference is made to the following description and accompanying drawings in which the presently preferred embodiment of the invention is shown by way of example. As the invention may be embodied in many forms without departing from the spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1A depicts a positive buoyancy embodiment of the gravoltaic cell of the present invention, whereby atoms on the surface of the stationary homogenous anode phase of the first species oxidize and dissolve into the compartmentalized homogeneous stationary phase of dissociated aqueous reactant cations of the second species as liberated cations (upward pointing arrows) of the first species. Said liberated cations of the first species are more buoyant than the surrounding homogeneous stationary reactant cation phase of the second species, said more buoyant liberated cations of the first species therefore migrate upward (upward pointing arrows) through an otherwise homogeneous stationary phase of cations of the second species and away from the anode phase of the first species. Said migration sustains the species disparity between the anode phase of the first species and the compartmentalized homogeneous stationary phase of dissociated aqueous reactant cations of the second species in immediate contact with the surface of the anode phase of the first species.

FIG. 1B depicts a negative buoyancy embodiment of the gravoltaic cell of the present invention, whereby atoms on the surface of the anode phase of the first species oxidize and dissolve into the compartmentalized homogeneous stationary phase of dissociated aqueous reactant cations of the second species as liberated cations (downward pointing arrows) of the first species. Said liberated cations of the first species are less buoyant than the surrounding stationary reactant cation phase of the second species, said less buoyant liberated cations of the first species therefore migrate downward (downward pointing arrows) through an otherwise homogeneous stationary phase of cations of the second species and away from the anode phase of the first species. Said migration sustains the species disparity between the anode phase of the first species and the compartmentalized homogeneous stationary phase of dissociated aqueous reactant cations of the second species in immediate contact with the surface of the anode phase of the first species.

FIG. 1C depicts a representation of the junction at the interface between the stationary homogenous anode phase of the first species of the positive buoyancy embodiment of the gravoltaic cell of FIG. 1A, represented by the black rectangle, and the stationary homogenous reactant cation phase, represented by the gray rectangle for the positive buoyancy embodiment.

FIG. 1D depicts a representations of the junction at the interface between the stationary homogenous anode phase of the first species of the negative buoyancy embodiment of the gravoltaic cell of FIG. 1B, represented by the black rectangle, and the stationary homogenous reactant cation phase, represented by the gray rectangle for the negative buoyancy embodiment.

FIGS. 1E through 1H depict the electrochemical disparity between individual reactant cations within the stationary homogenous reactant cation phase of the second species represented by the black crosses at the interface between the stationary homogenous anode phase (black rectangle) of the first species of the positive buoyancy embodiments of the gravoltaic cell of FIG. 1C.

FIGS. 1J through 1M depict the electrochemical disparity between individual reactant cations within the stationary homogenous reactant cation phase of the second species represented by the black crosses at the interface between the stationary homogenous anode phase (black rectangle) of the first species of the negative buoyancy embodiments of the gravoltaic cell of FIG. 1D.

FIG. 1P depicts a rotating disk electrode, such as used in rotating disk electrode voltammetry, immersed in a fluid (fluid shown by curved arrows). The rotation of the disk produces a vortex that drags fresh reactant material towards the electrode surface where it can react with the rotating electrode and pushes used fluid away from the rotating disk electrode. The rotating disk electrode accomplishes material migration by means of rotation, gravoltaic cells of the present invention accomplishes material migration by means of positive and negative buoyancy.

For gravoltaic cells of the present invention said migration consists of the migration of liberated cations of the first species away from the anode phase of the first species, and the migration of the fresh reactant cations of the cation phase of the second species towards the anode phase of the first species as depicted in FIGS. 1A through 1M.

FIG. 2 is a simplified experimental U tube setup (not a part of the present invention) for exploring and demonstrating the various anode potentials developed by various species disparities between an anode 25 of the first species in contact with various aqueous reactant cations of various second species 27, as measured against a single reference electrode in contact with a single reference cation species. The molar concentration of the various reactant cation species 27 and the molar concentration of the single reference cation species 28 are all 0.1 molar concentration, thus minimizing the effects of concentration differences.

FIG. 3 depicts a vertically oriented experimental setup of a negative buoyancy preferred embodiment of the electrochemically active dissimilar anode/cation species junction gravoltaic cell of the present invention.

FIG. 4 depicts a vertically oriented experimental setup of a positive buoyancy preferred embodiment of the electrochemically active dissimilar anode/cation species junction gravoltaic cell of the present invention.

FIG. 5 depicts the horizontally oriented control setup, used as a control for comparison against the vertically oriented negative buoyancy experimental setup depicted in FIG. 3 and used as a control for comparison against the vertically oriented positive buoyancy experimental setup depicted in FIG. 4.

FIG. 6 depicts a manual assaying and correlating system comprising; input leads A and B, a millivolt meter mV, a load resistance switch Sw1, and a variable load resistance R_{L}, connected to a gravity-sustained electrochemically active dissimilar anode/cation species junction gravoltaic cell of the present invention. 20

FIG. 7 depicts a generic commercially available electrochemical impedance spectroscopy (EIS) setup for testing the gravoltaic cell of the present invention.

FIG. 8 depicts a simplified schematic overview of the operating principles of the gravity-sustained electrochemically active dissimilar anode/cation species junction gravoltaic cell of the present invention. Gravitation energy enters the cell at step 1 and electrical energy exits the cell at step 5.

FIG. 9A depicts the yet another negative buoyancy preferred embodiment of the gravoltaic cell of the present invention. The container 203 shown in FIG. 9A contains a reactant cation phase 204 and a reference cation phase 206 which are partially diffused into each other.

FIG. 9B depicts the container and the electrodes used in the preferred embodiment of the galvoltaic cells of FIG. 9A without the cation phases 204 and 206.

FIG. 10 depicts the preferred embodiment of the gravoltaic cell of FIG. 9A. The container 203 represented in FIG. 10 contains a reactant cation phase 204 in contact with anode phase 210, a reference cation phase (dark gray area) in contact with cathode 211.

FIG. 11 depicts the stilt yet another preferred embodiment of a gravoltaic cell of the present invention.

GRAPH 1 depicts the first 15 minutes of the disclosed experimental evidence.

GRAPH 2 depicts the loading effect of an external electrical load resistance.

GRAPH 3 depicts the difference between the control setup output energy and the experimental setup output energy.

GRAPH 4 depicts the gravitational energy converted to electrical energy by the experimental setup over that of the control setup.

### DETAILED DESCRIPTION OF THE PREFERRED EMBODIMENTS

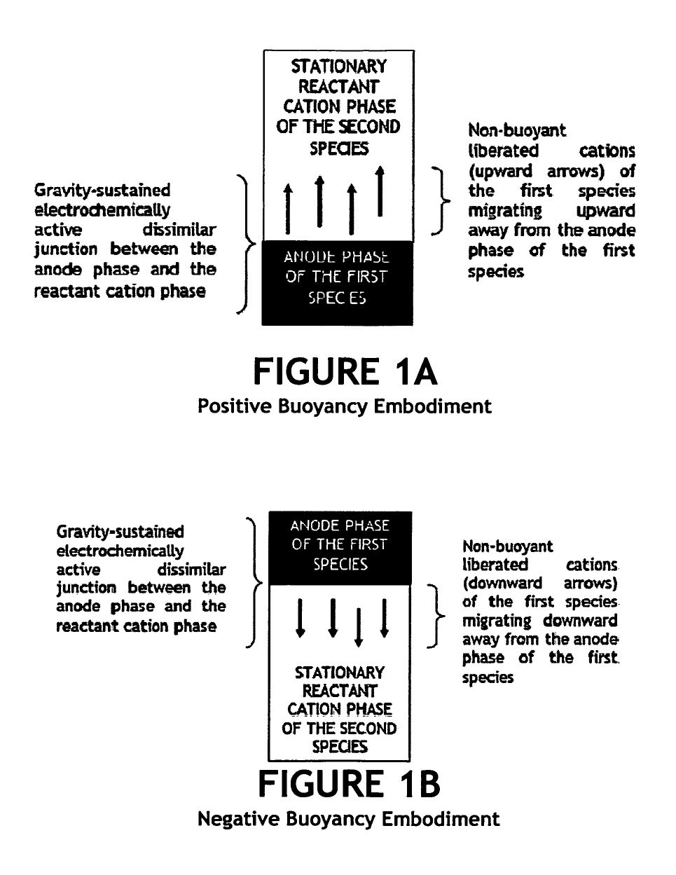

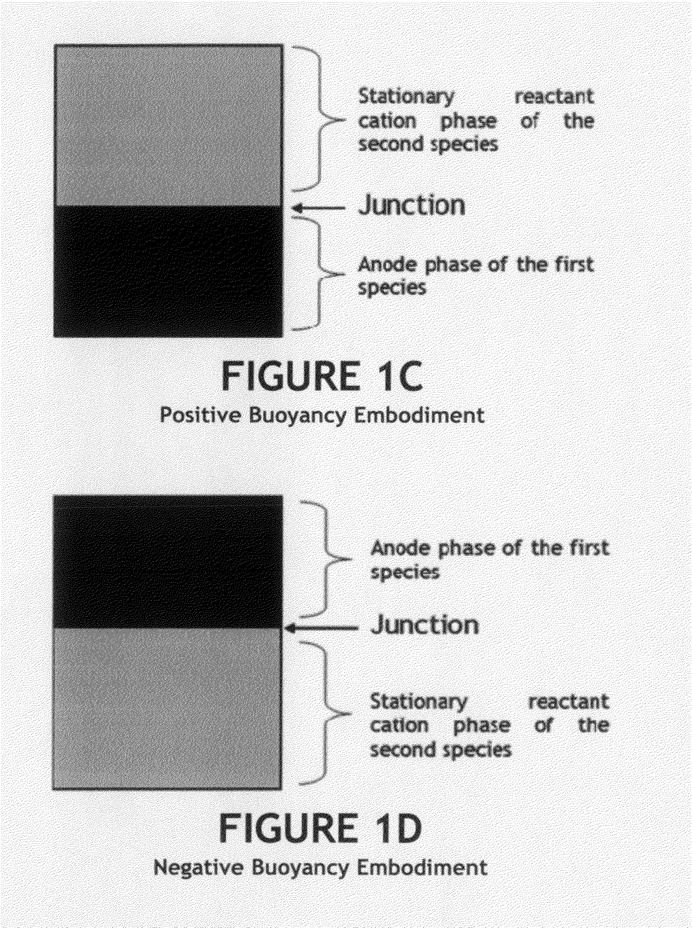

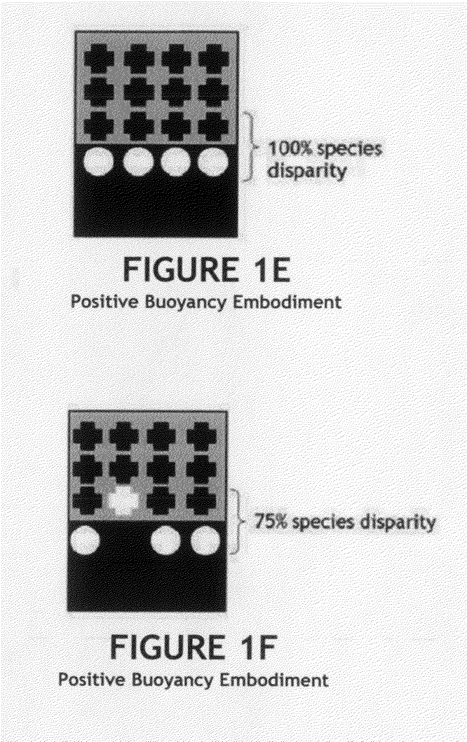

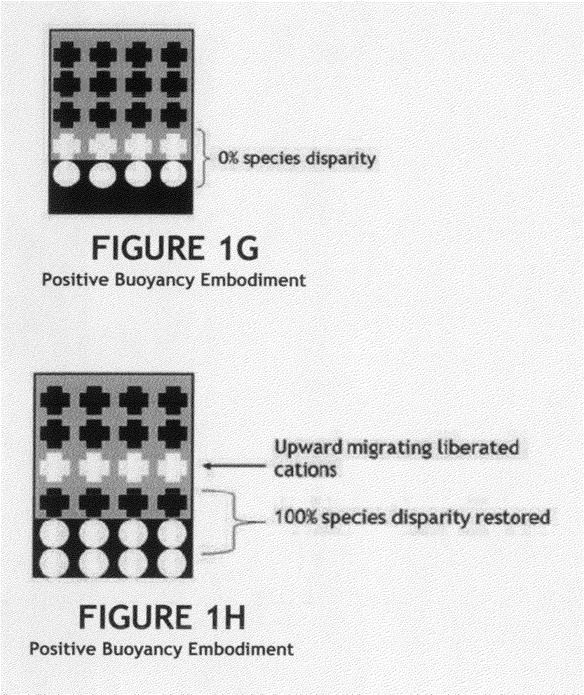

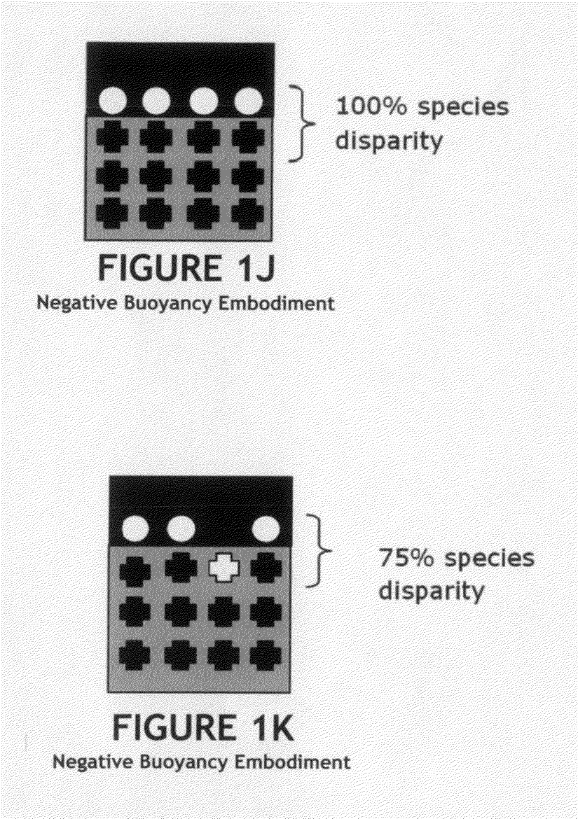

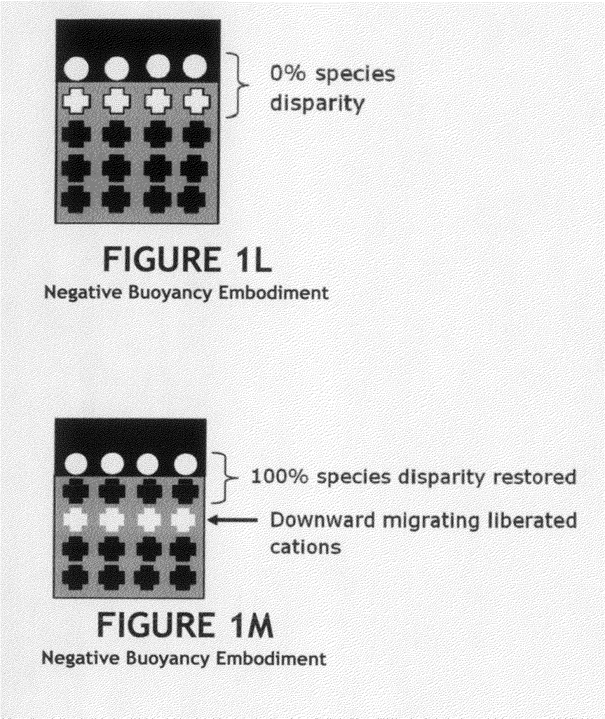

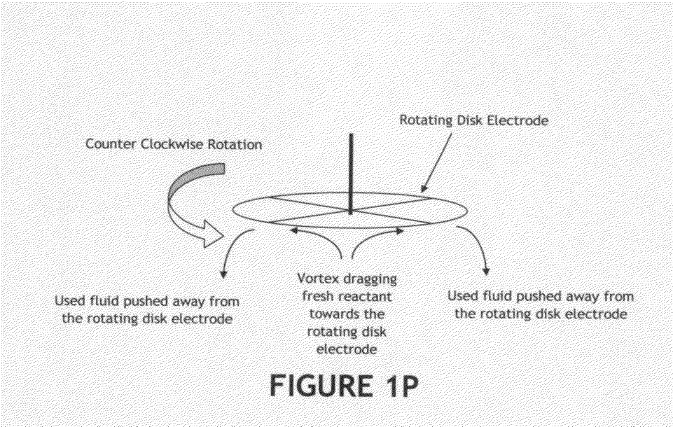

Referring now to the drawings, FIG. 1P depicts a rotating disk electrode, sometimes used in voltammetry (a category of electroanalytical methods used in analytical chemistry and various industrial processes), immersed in a fluid. The rotation of the disk produces a vortex that drags fresh reactant material towards the electrode surface where it can react with the rotating electrode and pushes used fluid away from the rotating disk electrode. The rotating disk electrode accomplishes material migration by means of rotation, friction, and electric charge; gravoltaic cells of the present invention accomplish material migration by means of positive and negative buoyancy.

Referring now to FIG. 1A depicts a positive buoyancy embodiment of the gravoltaic cell of the present invention, whereby atoms on the surface of the stationary homogenous anode phase of the first species oxidize dissolve into the compartmentalized homogeneous stationary phase of dissociated aqueous reactant cations of the second species as liberated cations (upward pointing arrows) of the first species. Said liberated cations of the first species are more buoyant than the surrounding homogeneous stationary reactant cation phase of the second species, said more buoyant liberated cations of the first species therefore migrate upward (upward pointing arrows) through an otherwise homogeneous stationary reactant cation phase of the second species and away from the anode phase of the first species. Said migration sustains the species disparity between the anode phase of the first species and the homogeneous stationary reactant cation phase of the second species in immediate contact with the surface of the anode phase of the first species.

Referring now to FIG. 1B depicts a negative buoyancy embodiment of the gravoltaic cell of the present invention, whereby atoms on the surface of the stationary homogenous anode phase of the first species oxidize and dissolve into the compartmentalized homogeneous stationary phase of dissociated aqueous reactant cations of the second species as liberated cations (downward pointing arrows) of the first species. Said liberated cations of the first species are less buoyant than the surrounding homogeneous stationary reactant cation phase of the second species, said less buoyant liberated cations of the first species therefore migrate downward (downward pointing arrows) through an otherwise homogeneous stationary reactant cation phase of the second species and away from the anode phase of the first species. Said migration sustains the species disparity between the anode phase of the first species and the homogeneous stationary reactant cation phase of the second species in immediate contact with the surface of the anode phase of the first species.

Referring now to FIG. 1C depicts the junction at the interface between the homogeneous stationary anode phase of the first species and the homogeneous stationary reactant cation phase for the positive buoyancy embodiment of the present invention. The homogeneous stationary anode phase of the first species is represented by the black rectangle. The homogeneous stationary reactant cation phase is represented by the gray rectangle.

Referring now to FIG. 1D depicts the junction at the interface between the homogeneous stationary anode phase of the first species and the homogeneous stationary reactant cation phase for the negative buoyancy embodiment of the present invention. The homogeneous stationary anode phase of the first species is represented by the black rectangle. The homogeneous stationary reactant cation phase is represented by the gray rectangle.

Referring now to FIG. 1E depicts the relatively large electrochemical disparity between individual cations (black crosses) within the homogeneous stationary reactant cation phase of the second species, and individual atoms (white circles) of the first species on the surface of the homogeneous stationary anode phase of the first species. Said disparity produces relatively elevated electrode reactions, relatively elevated electrode potential, relatively elevated cell voltage, relatively elevated anode/cation junction current, relatively elevated current flow through an external load resistance, and relatively elevated electrical energy transferred to and dissipated by an external load resistance.

Referring now to FIG. 1F depicts a liberated cation (white cross) of the first species oxidized and dissolved into the solution of the homogeneous stationary reactant cation phase (black crosses) of the second species as a newly liberated cation (white cross) of the first species. The total species disparity is slightly reduced.

Referring now to FIG. 1G depicts the reactant cations (black crosses) of the second species displaced away from the anode phase (black rectangle) of the first species by liberated cations (white crosses) of the first species. Since the liberated cations (white crosses) in immediate contact with the atoms of the anode phase (white circles) are the same species, there is no species disparity at the junction between the homogeneous stationary anode phase of the first species and the homogeneous stationary reactant cation phase of the second species. Said lack of species disparity produces relatively reduced electrode reactions, relatively reduced electrode potential, relatively reduced cell voltage, relatively reduced anode/cation junction current, relatively reduced current flow through an external load resistance, and relatively reduced electrical energy transferred to and dissipated by an external load resistance.

Referring now to FIG. 1H depicts the upward migration of relatively more buoyant liberated cations (white crosses) of the first species away from the homogeneous stationary anode phase of the first species (black rectangle) and the downward migration of relatively more buoyant reactant cations (black crosses) of the homogeneous stationary reactant cation phase of the second species. This action reestablishes the species disparity depicted in FIG. 1E. In practice, however, due to the friction and electrical charges of the inner surface of the reaction vessel slowing the migration of buoyant liberated cations (white crosses) of the first species in contact with the inner surface of the reaction vessel relative to the buoyant liberated cations (white crosses) of the first species more distant from the inner surface of the reaction vessel, the upward migration of buoyant liberated cations (white crosses) of the first species is hemispherical pot shown) rather than translational.

Referring now to FIG. 1J depicts the relatively large electrochemical disparity between individual cations (black crosses) within the homogeneous stationary reactant cation phase of the second species, and individual atoms (white circles) of the first species on the surface of the homogeneous stationary anode phase of the first species. Said disparity produces relatively elevated electrode reactions, relatively elevated electrode potential, relatively elevated cell voltage, relatively elevated anode/cation junction current, relatively elevated current flow through an external load resistance, and relatively elevated electrical energy transferred to and dissipated by an external load resistance.

Referring now to FIG. 1K depicts a liberated cation (white cross) of the first species oxidized and dissolved into the solution of the homogeneous stationary reactant cation phase (black crosses) of the second species as a newly liberated cation (white cross) of the first species. The species disparity is slightly reduced.

Referring now to FIG. 1L depicts the reactant cations (black crosses) of the second species displaced away from the anode phase (black rectangle) of the first species by liberated cations (white crosses) of the first species. Since the liberated cations (white crosses) in immediate contact with the atoms of the anode phase (white circles) are the same species, there is no species disparity at the junction between the homogeneous stationary anode phase of the first species and the homogeneous stationary reactant cation phase of the second species. Said lack of species disparity produces relatively reduced electrode reactions, relatively reduced electrode potential, relatively reduced cell voltage, relatively reduced anode/cation junction current, relatively reduced current flow through an external load resistance, and relatively reduced electrical energy transferred to and dissipated by an external load resistance.

Referring now to FIG. 1M depicts the downward migration of relatively less buoyant liberated cations (white crosses) of the first species away from the homogeneous stationary anode phase of the first species (black rectangle) and the upward migration of relatively more buoyant reactant cations (black crosses) of the homogeneous stationary reactant cation phase of the second species. This action reestablishes the species disparity depicted in FIG. 1J. In practice, however, due to the friction and electrical charges of the inner surface of the reaction vessel slowing the migration of buoyant liberated cations (white crosses) of the first species in contact with the inner surface of the reaction vessel relative to the buoyant liberated cations (white crosses) of the first species more distant from the inner surface of the reaction vessel, the downward migration of buoyant liberated cations (white crosses) of the first species is hemispherical (not shown) rather than translational.

The following is experimental evidence of the elevated performance of the active dissimilar anode/cation species junction disparity of the gravoltaic cell of the present invention.

A concentration cell is a limited form of a galvanic cell. Because an order of magnitude concentration difference produces less than 30 millivolts at room temperature, concentration cells are not typically used for energy storage. Concentration cells are limited by their driving disparity between an anode of the first species in contact with a reactant of the same species; that is, a passive similar anode/cation concentration junction disparity formed at the junction between an anode of a first species and a reactant of the same first species in contact with the anode. The preferred embodiments of the present invention overcomes this disadvantage by utilizing an active dissimilar anode/cation species junction disparity formed at the junction between an anode phase of one species and an aqueous reactant cation phase of a different species in immediate contact with the surface of the anode phase.

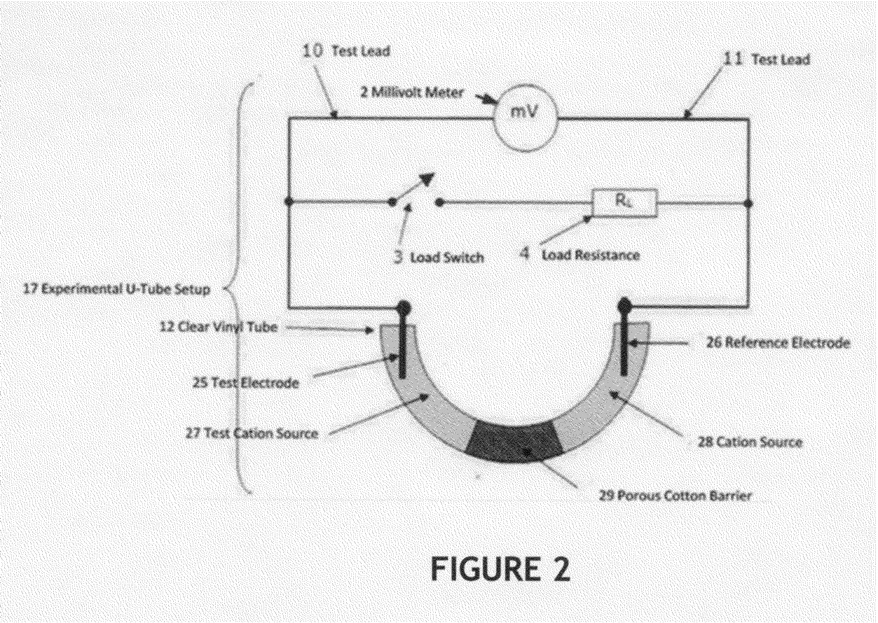

The assertion of the active dissimilar anode/cation species junction disparity is indeed more electrochemically active than the passive similar anode/cation concentration junction disparity is tested. Now referring to FIG. 2, the experimental U tube setup 17 demonstrates that a disparity between an anode 25 of the first species in contact with aqueous test reactant cations 27 of a second species of equal molar concentration as the reference cation source 28, at room temperature, will generate an elevated electrical potential compared to the less than 30 millivolts at room temperature of a standard concentration cell.

The experimental U tube setup 17 serves as one of several methods for selecting candidate materials for future investigation and possible use in gravoltaic cells of the present invention. The experimental U tube setup 17 has the advantages of quickly assaying the relative output voltage at the millivolts meter 2 of various dissimilar anode/cation species junctions under test under both load resistance and no-load resistance conditions by way of load resistance switch 3.

With the electrochemical environment of the reference electrode 26 and reference cation source 28 being the same for all the related investigations, and with the same aqueous anions (chloride anions in this case) and the same aqueous anion concentration in both the anode side and the cathode side, the only variable is the relative differences in the test reactant cation species 27 in immediate contact with the surface of anode 25. The experimental U tube setup 17 thus eliminates the influence of molar concentration variations by using electrolytic solutions of equal molar concentrations in both halves of the tube 12, and minimizes the influence of gravity by its shape and orientation to the field of gravity.

The focus of the experimental U tube setup 17 is on the specific electrochemistry at each of the various electrochemically active dissimilar anode/cation species junctions between the anode 25 of the first species and aqueous test reactant cations 27 of various second species under investigation relative to a common electrochemical environment at the cathode 26.

Referring again to FIG. 2 depicting a typical U tube test setup 17 comprising a U shaped clear vinyl plastic tube 12, porous cotton barrier 29, test electrode 25 and reference electrode 26, test reactant cation source 27 and reference cation source 28, test leads 10 and 11, load switch 3, load resistance 4, and millivoltmeter 2.

The U tube setup assays the electrochemically active dissimilar anode/cation species junction potentials and relative junction resistance formed at the interface between the anode 25 of one species and various test reactant cations 27 of any sample dissimilar test reactant cation species 27. For the following results, the open circuit voltage is measured with load switch 3 open, and the closed circuit voltage is measured with load switch 3 closed. The reference electrode 26 and the test electrode 25 are both the same copper electrodes for each test, and all electrolytic solutions have the same 0.1 mot concentration, ruling out a disparity of molar concentration as the source of the generated electrical energy.

CONTROL SETUP—A control setup is made using a 0.1 mol Copper chloride solution for both the test reactant cation source 27 and reference cation source 28. Said control setup generated zero mV (minus microscopic pitting, oxide and other electrode inequality-produced voltage errors).

EXPERIMENTAL SETUP RESULTS Experimental setups are made using a 0.1 mol Copper chloride solution for the reference cation source 28, and various 0.1 mol test solutions having cations other than copper.
1. Copper chloride reference solution 28 and a sodium chloride test reactant cation source 27 generated 123.4765 mV open circuit, and a load voltage of 97.77641 millivolts across a 1000 ohm external load resistance, and having an internal cell resistance of 2,628 ohms.
2. Copper chloride reference solution 28 and a calcium chloride test reactant cation source 27 generated 156.3418 mV open circuit, and a load voltage of 151.5471 millivolts across a 1000 ohm external load resistance, and having an internal cell resistance of 316.38 ohms.
3. Copper chloride reference solution 28 and a potassium chloride test reactant cation source 27 generated 53.12109 mV open circuit, and a load voltage of 39.19749 mV across a 1000 ohm external load resistance, and having an internal cell resistance of 3,376.74 ohms.
4. Copper chloride reference solution 28 and a Lithium chloride test reactant cation source 27 generated 128.6901 mV open circuit, and a load voltage of 100.6037 mV across a 1000 ohm external load resistance, and having an internal cell resistance of 2,791.79 ohms.

CONCLUSION, the test cell results seem to confirm the assertion that the active dissimilar anode/cation species junction disparity is indeed more electrochemically active than the passive similar anode/cation concentration junction disparity of the control setup. Concentration cells generally produces less than 30 millivolts at room temperature, while 3 of the 4 observed test cell results were well over 100 millivolts, at room temperature. The different observed voltages and other characteristics are functions of the different cation species at each test anode junction.

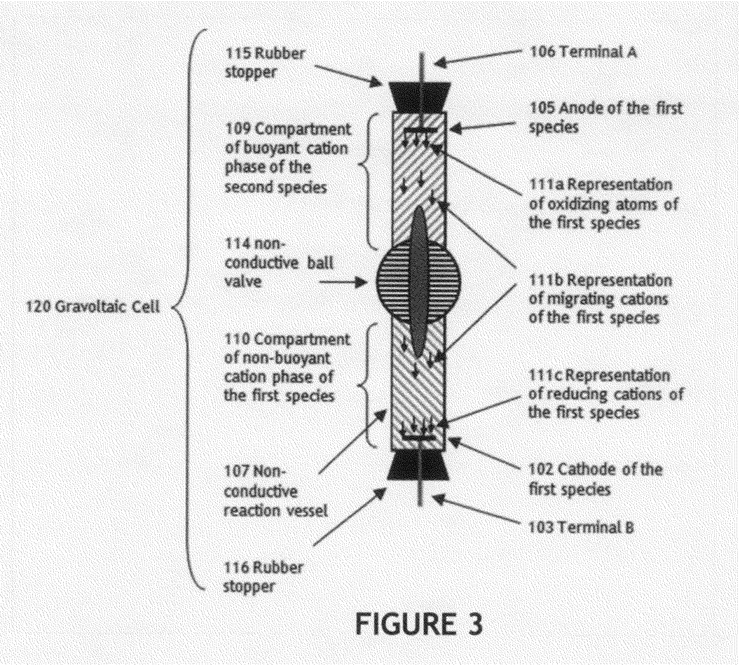

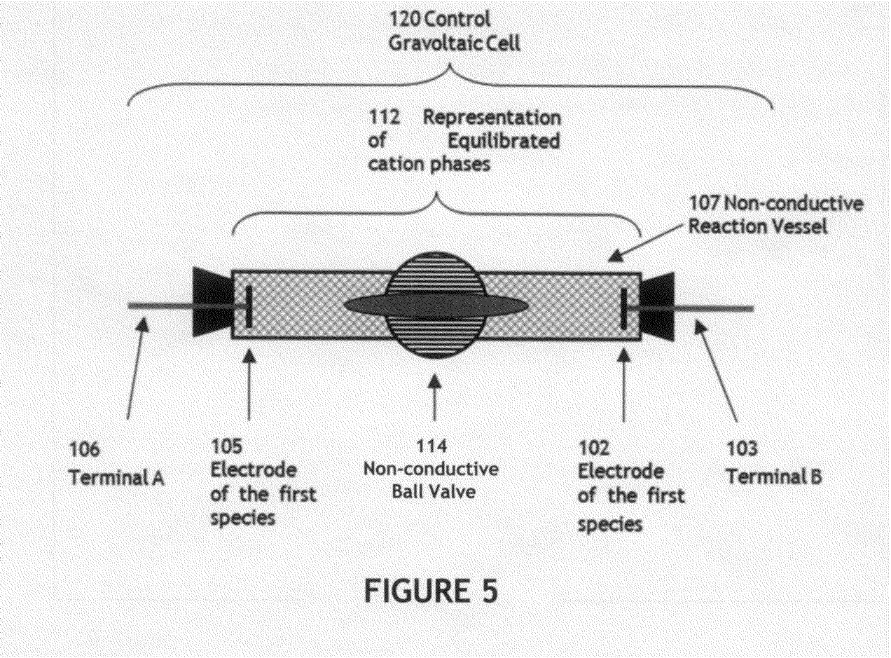

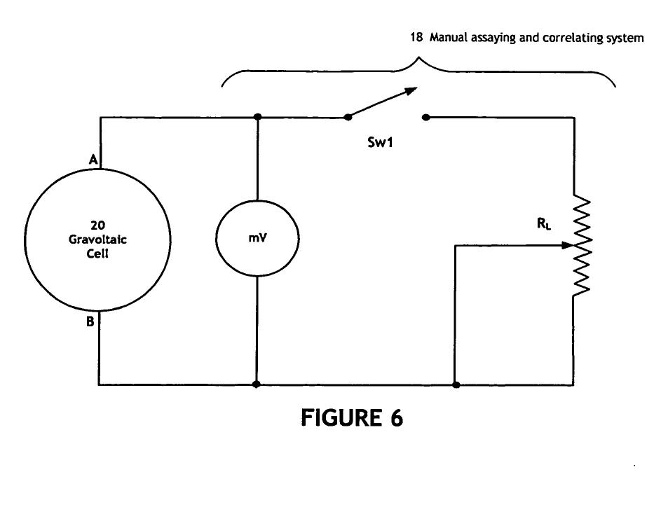

The individual performances of each U-tube test are assayed, and correlating the assay results for each cell under investigation with their relative usefulness as sources of electrical energy suggests that the Copper chloride reference 28 with calcium chloride test reactant cation source 27 may be a good candidate for future investigation, wherein a gravoltaic cell of the present invention is assembled as depicted in FIGS. 3, 4, 5, 9A, 9B, 10, and 11, and assayed as depicted in FIGS. 6, 7, 9A, and 11. The assay data may be (but not limited to) displayed as graphs and analyzed, such as depicted in GRAPHS 1, 2, 3, AND 4.

The elevated generated voltage and the diminished cell resistance of the electrochemically active dissimilar anode/cation species junction are a function of the elevated oxidation reactions, and not a function of molar concentration variations, since all solutions used in these examples are the same 0.1 mol concentration.

When the experimental results are compared to the control result, it is observed that the various electrical energies produced by the various experimental setups are functions of the relative differences in the electrochemistry at the dissimilar anode/cation species junction.

The preferred embodiments of the present invention overcomes the disadvantages of the concentration disparity of the concentration cell by utilizing a gravity-sustained electrochemically active dissimilar species junction formed between an anode phase of a first species and a homogeneous stationary reactant cation phase of the second species. Said gravity-sustained electrochemically active dissimilar species junction is depicted in FIGS. 1A, 1C, and 1E through 1H for the positive buoyancy embodiment of the present invention, and depicted in FIGS. 1B, 1D, and 1J through 1M for the negative buoyancy embodiment of the present invention.

The preferred embodiments of the present invention provides both 1) the largest achievable electrochemical junction disparity between the anode phase of the first species and the reactant cations of the homogeneous stationary reactant cation phase of the second species in immediate contact with the surface of the anode and 2) the highest achievable number of reactant cations of the second species in immediate contact with the surface of the anode phase of the first species. This provides the large electrochemical junction disparity needing to produce a sufficient electromotive force, while at the same time provides a sufficiently high number of reactant cations of the second species to react with the anode of the first species to produce a useful electrical current flow through an external electrical load resistance.

The larger (greater than 30 millivolts) junction potential (voltage) of the active dissimilar anode/cation junction species disparity is observed experimentally in test “U tube” cells disclosed in this specification.

Advantages of the dissimilar anode/cation junction species disparity utilized by the preferred embodiments of the present invention, over the concentration disparity of the concentration cell, are a) the ability to abandon the limitations of the passive similar anode/cation concentration junction disparity formed at the interface between the anode phase of one species in contact with an electrolytic solution of the same species, and b) the ability to exploit an electrochemically active dissimilar anode/cation species junction formed at the interface between the anode phase of the first species and homogeneous stationary reactant cation phase of the second species in immediate contact with the surface of the anode phase.

Further advantages of the species disparity utilized by the preferred embodiments of the present invention, over the concentration disparity of the concentration cell, are relatively diminished internal cell resistance, relatively elevated electrode reactions, relatively elevated electrode potential, relatively elevated cell voltage, relatively elevated anode/cation junction current, relatively elevated current flow through an external load, and relatively elevated electrical energy transferred to and dissipated by an external load, compared to that of the passive similar anode/cation concentration junction disparity utilized by the concentration cell.

Now referring to FIG. 3 depicts a generalized representation of the negative buoyancy mode of the preferred embodiments of the gravity-sustained electrochemically active dissimilar anode/cation species junction gravoltaic cell of the present invention 120 comprising; an electrically nonconductive reaction vessel 107, comprising a first compartment containing a homogeneous stationary less buoyant reference cation phases 110 of the first species disposed in the first compartment, and a second compartment containing a homogeneous stationary more buoyant reactant cation phases 109 of the second species disposed in the second compartment, migrating cations 111a, 111b and 111c, and two similar electrically conductive electrodes of a first species 102 and 105 and two output terminals 103 and 106, wherein electrode 105 is in contact with the more buoyant reactant cation phase 109 and electrode 102 is in contact with the less buoyant reference cation phase 110, and a gravitational field that extends into said two stationary phases that sustains a buoyancy separation of said two homogeneous stationary cation phases, wherein output terminals 103 and 106 are connected to points “A” and “B” of the assaying and correlating system 18 depicted in FIG. 6.

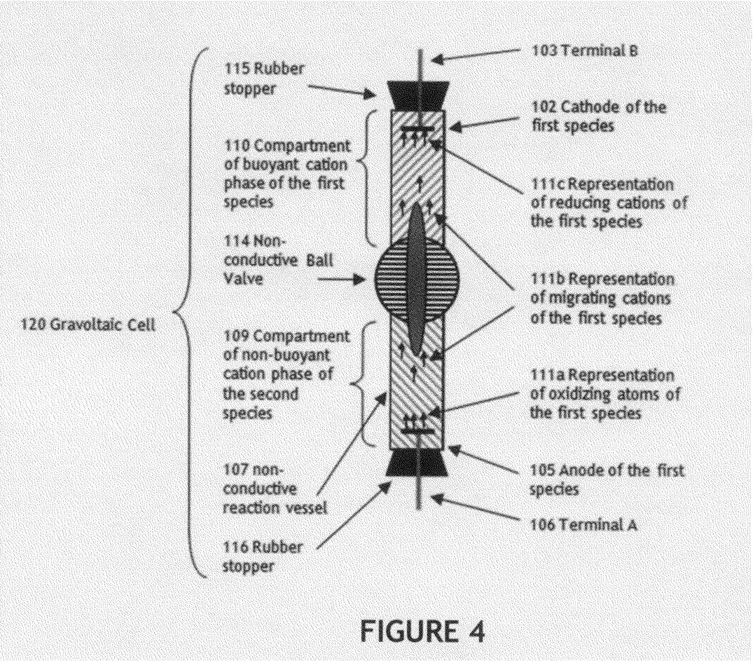

Now referring to FIG. 3 and FIG. 4, a species disparity between an anode phase 105 of a first species (such as but not limited to solid copper) and a reactant cation phase 109 of a second species (such as but not limited to aqueous calcium cations) in contact with anode phase 105, wherein said species disparity stores greater potential energy than a molar concentration disparity utilized by the concentration cell, wherein the act of attempting to equalizing said species disparity releases more energy than the act of attempting to equalizing an molar concentration difference, wherein said driving disparity of the preferred embodiments of the present invention is a disparity between an anode phase 105 of a first species in contact with a reactant cation phase 109 of a second species, wherein by the second law of thermodynamics,

Having two separate stationary homogenous phases (the anode phase and the reactant cation phase) in the same compartment of the same reaction vessel is a highly non-random event and as a result, the two phases form a high potential energy junction. The system will attempt to remedy this by dissolving the stationary homogenous anode phase 105 into the stationary homogenous reactant cation phase 109 to form a uniform phase throughout. However, the energy of gravity, through the action of positive buoyancy for positive buoyancy embodiments of the preferred embodiments of the present invention or negative buoyancy for negative buoyancy embodiments of the preferred embodiments of the present invention forecloses said remedy by causing a migration of newly liberated cations 111a of the first species away from the anode phase 105 of the first species, thus sustaining the species disparity,

Said gravity-sustained electrochemically active anode-junction species disparity gravoltaic cells comprising the steps of; providing a electrochemically active anode junction-species disparity at the junction between an anode phase 105 of the first species (such as but not limited to solid copper) and a reactant cation species phase 109 of a second species (such as but not limited to aqueous calcium cations) in contact with said anode phase 105, comprising; an anode phase 105 of the first species having a first placement and in contact with a first compartmentalized homogeneous stationary phase of dissociated aqueous reactant cations of the second species 109 (such as but not limited to a copper anode in contact with aqueous calcium cations) having a first placement, wherein said first placement of the first stationary homogeneous reactant cation phase 109 of a second species is maintained by gravity by either negative buoyancy for positive buoyancy preferred embodiments of the present invention or by positive buoyancy for negative buoyancy the preferred embodiments of the present invention wherein said first placement of the stationary homogeneous phase of a reactant cation phase 109 of a second species occupies the upper compartment of the reaction vessel 107 for negative buoyancy preferred embodiments of the present invention, and said first placement of the stationary homogeneous phase of a reactant cation phase 109 of a second species occupies the lower compartment of the reaction vessel 107 for the positive buoyancy preferred embodiments of the present invention, and

providing an electrochemically passive similar cathode/cation species junction comprising, a cathode phase 102 of the first species having a second placement and in contact with a stationary homogeneous phase of dissociated aqueous reference cation phase 110 of the first species (such as but not limited to a copper cathode in contact with aqueous copper cations) having a second placement, wherein said second placement of the stationary homogeneous phase of dissociated aqueous reference cations 110 of the first species is maintained by gravity through either positive buoyancy for positive buoyancy preferred embodiments of the present inventions or by negative buoyancy for negative buoyancy preferred embodiments of the present invention, wherein said second placement of the stationary homogeneous phase of reference cation phase 110 of the first species occupies the upper compartment of the reaction vessel 107 for the positive buoyancy preferred embodiments of the present invention, and said second placement of the stationary homogeneous phase of reference cation phase 110 of the first species occupies the lower compartment of the reaction vessel 107 for the negative buoyancy preferred embodiments of the present invention, and providing said two distinct stationary homogeneous phases of dissociated aqueous cations differing chemically in species and differing physically in relative buoyancy, but not necessarily differing in relative concentration wherein each phase is compartmentalized from the other phase by their difference in relative buoyancy, wherein a first compartmentalized homogeneous stationary phase of dissociated aqueous reference cations of the first species 110 having dissociated aqueous cations of the first species (such as but not limited to aqueous copper cations) and
wherein a second stationary homogeneous aqueous phase of a reactant cation phase 109 of a second species having dissociated aqueous cations of the second species (such as but not limited to aqueous calcium or other metal cations which are dissimilar to the cations of the first species), wherein both the homogeneous phase of aqueous solvent (such as but not limited to water) and aqueous anions (such as but not limited to chloride) and the two distinct stationary homogeneous phases one phase of dissociated aqueous reactant cation phase 109 and the other phase of dissociated reference cation phase 110 are disposed within a reaction vessel 107, wherein one stationary homogeneous phase of dissociated aqueous cations having a greater relative buoyancy and the other said distinct stationary homogeneous phase of dissociated aqueous cations having a lesser relative buoyancy, wherein both said two distinct stationary homogeneous phases of dissociated aqueous cations are held separate and stationary by their difference in relative buoyancy, and wherein an upper stationary homogeneous phase of dissociated aqueous cations having the greater relative buoyancy and a lower stationary homogeneous phase of dissociated aqueous cations having the lesser relative buoyancy, wherein the stationary homogeneous phase of a reactant cation phase 109 of a second species is in contact with an anode phase 105 and the stationary homogeneous phase of dissociated aqueous reference cation phase 110 of the first species is in contact with a cathode phase 102, and providing a stationary homogeneous phase of aqueous solvent (such as but not limited to water) and aqueous anions (such as but not limited to chloride anions) disposed throughout the reaction vessel 107 along with the said two distinct stationary homogeneous phases of dissociated aqueous cation phases 109 and 110 also disposed within said reaction vessel 107, wherein both said stationary phases of a homogeneous mixture of solvent and dissociated anions, and said two said phases of dissociated aqueous cation phase 109 and 110 are disposed within said reaction vessel 107, wherein the incompressibility of water or other solvent tends to form a homogeneous distribution throughout the reaction vessel 107, wherein the negative electric charged anions tend to repel each other to form a homogeneous anion distribution throughout the reaction vessel 107, and wherein the said homogeneous distribution of negative charged anions tends to attract the positive charged aqueous cation phases 109 and 110 which in turn tends to homogenize any aqueous cation concentration differences that may be existent within each of the said two phases 109 and 110 of dissociated aqueous cations, and both said two distinct stationary homogeneous phases of dissociated aqueous cation phases 109 and 110 are disposed within said mixture of solvent and dissociated anions, and providing an external electrical load resistance connected across the anode and cathode, wherein said external electrical load resistance is located within the assaying and correlating system 118, and providing an assaying and correlating systems for gravoltaic cells: Referring now to FIG. 6 depicting a manual assaying and correlating system comprising; the gravoltaic cell under investigation 20, a millivolt meter MV, load switch Sw1, and variable load resistance R_{L}. When the Sw1 is open, the load resistance does not appear across the output terminals A and B and the open circuit or no-load voltage of the gravoltaic cell under investigation is measured. When the Sw1 is closed by hand, the resistance of the variable load resistor R_{L} appears across the output terminals A and B, and the closed circuit or load voltage of the gravoltaic cell under investigation is measured. The variable resistance R_{L} is incrementally set at various resistance values to obtain a number of data points for analyzing various characteristics of each gravoltaic cell under investigation. The operator calculates, by hand, the internal cell resistance of the gravoltaic cell under investigation by measuring the difference between the open circuit voltage and the closed circuit voltage.

A practical electrical power source which is a linear electric circuit may, according to Thevenin's theorem, be represented as an ideal voltage source in series with impedance. This resistance is termed the internal resistance of the source. When the power source delivers current, the measured e. m. f. (voltage output) is lower than the no-load voltage; the difference is the voltage (the product of current and resistance) drop caused by the internal resistance. The internal resistance of a gravoltaic cell under investigation is calculated by the equation,

$${R}_{batt} = \frac{( {V}_{drop} ) \times ( RL )}{{V}_{drop} + {V}_{batt}}$$

Where V_{drop} is the difference in your two readings above V_{batt} is the open circuit voltage measured above RL is the resistor you load the battery with R_{batt} is the battery internal resistance. The concept of internal resistance applies to all kinds of electrical sources and is useful for analyzing the performance of various gravoltaic cells under investigation.

From the test data obtained, the operator calculates and ranks such cell properties as the levels of electrode reactions, cell resistance, electrode potentials, and cell voltages, anode/cation junction currents, current flows through external loads, and electrical energy transferred to and dissipated by external loads. From the calculations and rankings, the operator correlates said cell properties with their relative usefulness as sources of electrical energy.

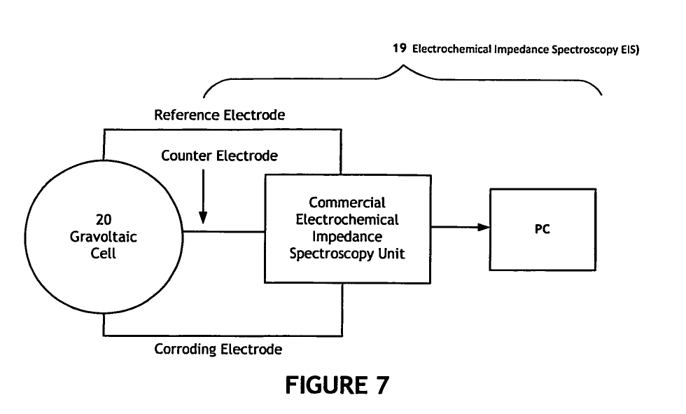

Referring now to FIG. 7, electrochemical impedance spectroscopy is abbreviated “EIS”. EIS is a tool for examining processes occurring at electrode surfaces. A small amplitude ac (sinusoidal) excitation signal (potential or current), covering a wide range of frequencies, is applied to the system under investigation and the response (current or voltage or another signal of interest) is measured. Due to the small amplitude of the excitation signal, the measurement can be carried out without significantly disturbing the properties being measured. Due to the wide range of frequencies used, the complex sequence of coupled processes such as, electron transfer, mass transport, chemical reaction, etc. can often be separated and investigated with a single measurement. It is routinely used in electrode kinetics and mechanism investigations, and in the characterization of batteries, fuel cells, and corrosion phenomena. Following the manufactures directions, a low amplitude alternating potential (or current) wave is imposed on top of a DC potential. The frequency is varied from as high as 10⁵ Hertz to as low as about 10⁻³ Hertz in one experiment in a set number (often between 5 and 10) steps per decade of frequency. Varying frequency from low to high frequency is also possible. The corrosion process usually forces the measured current to be out of phase (denoted by the phase angle) with the input voltage. Dividing the input voltage by the output current furnishes the impedance. The variation in impedance (magnitude and phase angle) is used for the interpretation. This technique is in essence built on the DC polarization resistance technique in which a direct current voltage (or current) ramp is imposed. EIS can be used to identify the rate limiting step, such as, but not limited to, charge-transfer resistance, a characteristic quantity for the charge-transfer step of an electrode reaction indicative of its inherent speed: a large charge-transfer resistance indicates a slow step.

Now referring to FIG. 3 the negative buoyancy preferred embodiments and FIG. 4 depicts the positive buoyancy preferred embodiments of the electrochemically active dissimilar anode/cation species junction gravoltaic cell of the present invention 120 wherein output terminals 103 and 106 are connected to points “A” and “B” of the assaying and correlating system 18 depicted in FIG. 6 and the electrochemically active dissimilar anode/cation species junction gravoltaic cell of the present invention 120 is under investigation by the assaying and correlating system 18 wherein in an attempt to equalize the species disparity between the anode phase 105 of the first species and aqueous reactant cation phase 109 of the second species, atoms on the surface of anode 105 oxidize into solution as the liberated cations of the first species 111a, said liberated cations of the first species 111a are less buoyant than the stationary phase of dissociated reactant cation phase 109 of the second species, said cations of the first species 111b migrate out of the the stationary phase of dissociated reactant cation phase 109 of the second specie and into the the stationary phase of less buoyant dissociated reference cation phase 110, thus sustaining the species disparity between the anode phase 105 of the first species and the stationary phase of dissociated reactant cation phase 109 of the second species, said migration cations of the first species 111c reduce out of solution onto the surface of cathode 102, and the electrons produced by the oxidation reactions exit the cell's anode phase 105 and flow into and through an external electrical load resistance located within the assaying and correlating system 118 and back to the cathode phase 102 of the cell where said electrons reduce cations of the first species out of solution and onto the surface of the cathode 102.

Testing various preferred embodiments of the present invention for any of the following:
a. electrode reactions
b. electrode potentials
c. total cell voltage
d. junction current
e. current flow through an external load resistance
f. electrical energy transferred to an external load resistance
g. rate limiting steps
h. electrochemical impedance spectroscopy results
i. other properties and characteristics, as indicated and necessary.

One or more of the test results and or one or more other properties and or characteristics of various preferred embodiments of the present invention under investigation may be correlated with their relative usefulness as sources of electrical energy.

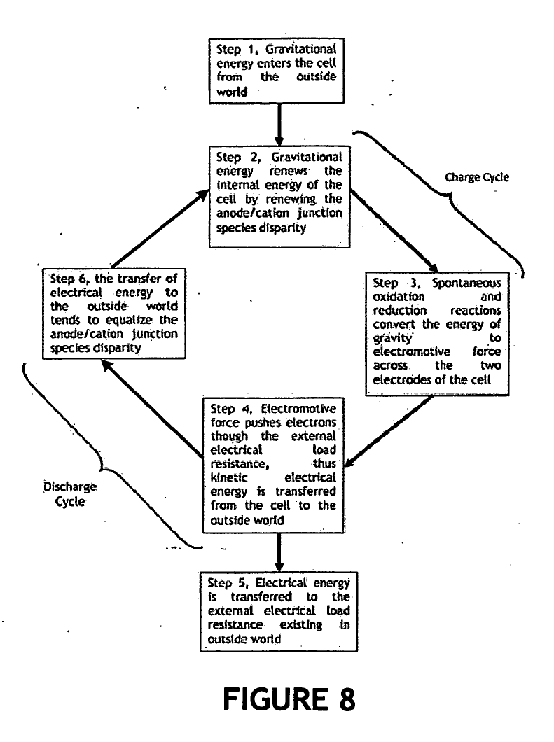

Referring now to FIG. 8, hereafter set forth is a brief overview of the operating principles of the gravity-sustained electrochemically active dissimilar anode/cation species junction gravoltaic cell of the present invention:

Step 1, gravitational energy enters the gravoltaic cell of the present invention from the outside world.

Step 2, Gravitational potential energy from the outside world acts to renew the internal mechanical potential energy (renews the species disparity between the anode phase of the first species and a homogeneous stationary reactant cation phase) of the cell wherein; for positive buoyancy mode embodiments of the present invention the action of positive buoyancy causes an upward migration of more buoyant liberated cations of the first species away from the anode phase of the first species and towards the cathode phase of the first species and the action of negative buoyancy causes a subsequent downward reconnecting of less buoyant reactant cations of the cation phase of the second species with the anode phase of the first species as depicted in FIGS. 1G and 1H, thus renewing and sustaining the species disparity between the anode phase of the first species and the reactant cations phase of the second species in contact with the anode phase of the first species and wherein, for negative buoyancy mode embodiments of the present invention the action of negative buoyancy causes a downward migration of less buoyant liberated cations of the first species away from the anode phase of the first species and towards the cathode phase of the first species and the action of positive buoyancy causes a subsequent upward reconnecting of more buoyant reactant cations of the cation phase of the second species with the anode phase of the first species as depicted in FIGS. 1L and 1M, thus renewing and sustaining the species disparity between the anode phase of the first species and the reactant cations phase of the second species in contact with the anode phase of the first species. Thus gravitational potential energy is converted to mechanical potential energy.

Step 3, now referring to FIGS. 3 and 4, in an attempt to equilibrate the species disparity between the anode phase 105 of the first species and the reactant cation phase 109 of the second species, spontaneous oxidation reactions at anode phase 105 and reduction reactions at cathode 102 occur, converting said gravitational potential energy (in the form of the internal mechanical potential energy of the physical species disparity between the anode phase of the first species and the homogeneous stationary reactant cation phase of the second species) into electromotive force or electrical potential energy across the two terminals 103 and 106 of cell, wherein atoms of the first species on the surface of the anode phase 105 of the first species in contact with the homogeneous stationary reactant cation phase 109 of the second species oxidize and dissolve into the solution of the homogeneous stationary reactant cation phase 109 of the second species as liberated aqueous cations 111a and 111b of the first species (represented by FIGS. 1F and 1K) while at the same time the aqueous cations 111c of the first species in contact with the cathode phase 102 of the first species reduce out of solution and plate out onto the surface of the cathode phase 102 of the first species. Thus mechanical potential energy is converted to electrical potential energy.

Steps 4 and 5, said electromotive force or potential, is sufficient to push electrons, produced by the oxidation reactions, though an external electrical load resistance located within the assaying and correlating system 118. Thus electromotive force or potential energy is converted into kinetic electrical energy (energy of electrons in motion) transferred from the cell 120 to the outside world.

Step 6 The transferred of said kinetic electrical energy to the outside world tends to weaken the species disparity between the anode phase 105 of the first species and the reactant cation phase 109 of the second species in contact with the anode phase 105 of the first species (as depicted in FIGS. 1F, 1G, 1K, and 1L). Back to step 1 where gravity through positive and negative buoyancy strengthens and restores the species disparity at the junction between the anode phase of the first species and the reactant cation phase of the second species represented in FIGS. 1H and 1M, thus restoring the potential energy of the cell by renewing the species disparity between the anode phase of the first species and a homogeneous stationary reactant cation phase.

All of the above steps and events occur simultaneously so that in any given instant the liberated cations of the first species liberated from the anode phase of the first species are not exactly the same cations plated out onto the surface of the cathode, and the electrons produced in the oxidation are not exactly the same electrons used in the reduction. The gravoltaic cell is capable of doing electrical work without any net chemical reaction occurring. The number of cations of the first and of the second species and the amount of electrode metal in the system does not change; it is the gravitationally induced distribution of these substances in the cell that provides the driving force.

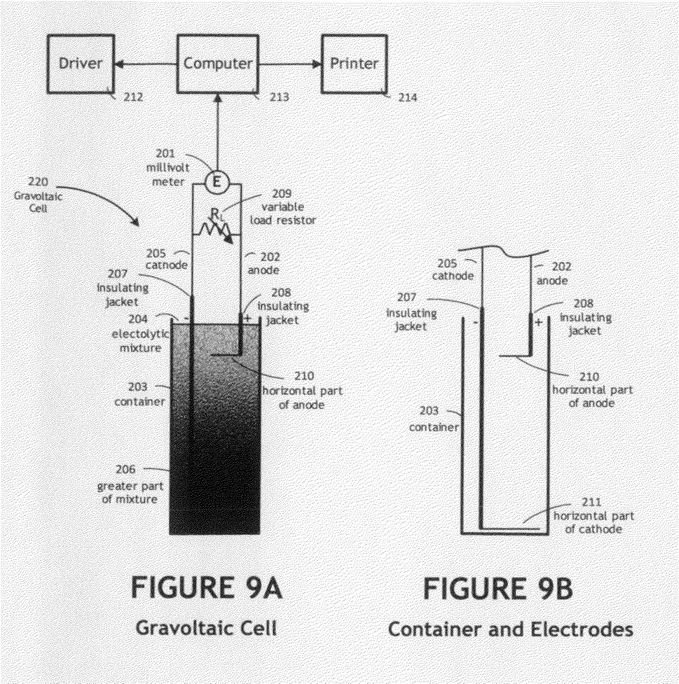

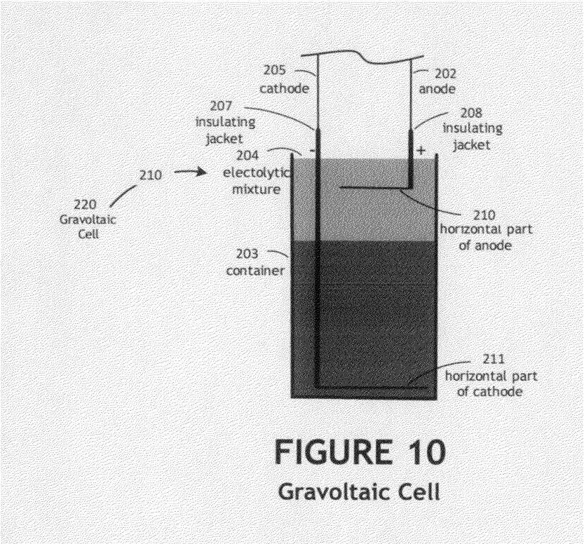

FIG. 9A depicts the yet another negative buoyancy preferred embodiment of the gravoltaic cell of the present invention. The container 203 shown in FIG. 9A contains a reactant cation phase 204 and a reference cation phase 206 which are partially diffused into each other.

FIG. 9B depicts the container and the electrodes used in the preferred embodiment of the galvoltaic cells of FIG. 9A without the two cation phases.

Referring now to FIGS. 9A and 9B, the preferred embodiment of the gravoltaic cell of the present invention 220 comprises: an electrically nonconductive container 203, preferably a glass jar or chemical resistant plastic, containing a reactant cation phase 204 and a reference cation phase 206 which are partially diffused into each other used by some of the preferred embodiments of the present invention, a first electrode 202 immersed in a reactant cation phase of the second species 204 in the upper compartment of the container 203, a second electrode 205 immersed in a reference cation phase 206 in the lower compartment of the container 203. The vertical portions of the electrodes 202 and 205 are insulated from the electrolyte by insulating jackets 207 and 208. Additionally, a variable load resistor 209 and a millivoltmeter 201 electrically connected across electrodes 202 and 205. The millivoltmeter 201 is interfaced with the computer 213. Various electrically nonconductive containers such as glass or chemical resistant plastic may be used as the container.

Two identical electrically conductive electrodes 202 and 205 positioned in the two cation phases 204 and 206. The vertical parts of said electrodes insulated from the electrolyte solution by insulating jackets 207 and 208, and means (not shown) to independently rise and lower electrode 202 and electrode 205 within said cation phases, and means (not shown) to secure and hold electrode 202 and electrode 205 in a stationary position relative to the two cation phases.

Electrodes are comprised of any electrically conductive material or any combination of electrically conductive materials. The physical composition of electrodes may include but not limited to smooth solid, abraded solid, wool, sponge or nano-particle composition of any electrically conductive material or of any combination of electrically conductive materials. The physical composition of electrodes may include but not limited to any combination of smooth solids, abraded solids, wools, sponges or nano-particles of any electrically conductive material or any combination of electrically conductive materials.

One or more catalytic agent may be used to increase the rate of oxidation and reduction. Some or all said catalytic agents may be part of the anode or the cathode or of both. Some or all said catalytic agents may be part of the more buoyant cation phase or the less buoyant cation phase or of both. Some or all said catalytic agent may be part of the anode/electrolyte interface or the cathode/electrolyte interface or of both.

Millivoltmeter 201 is electrically connected across electrodes 202 and 205 and interfaced with the computer. The variable resistance 209 is set and held at various stationary resistances to assay a number of cell characteristics or can be continuously adjusted to assay other cell characteristics.

A personal computer 213 records and assay the incoming data, and a printer 214 and monitor display connected to the personal computer 213.

Referring now to FIG. 10, the gravoltaic cell 220 of the present invention is depicted. The container represented in FIG. 10 contains a more buoyant reactant cation phase 204. The less buoyant cation phase occupies the lower portion of the container 203 and the more buoyant cation phase occupies the upper portion of the container 203.

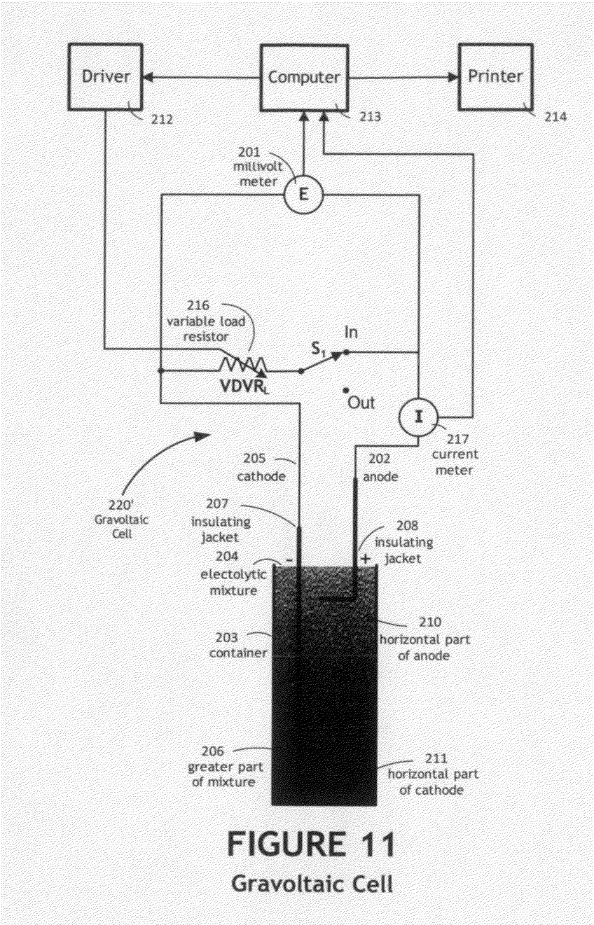

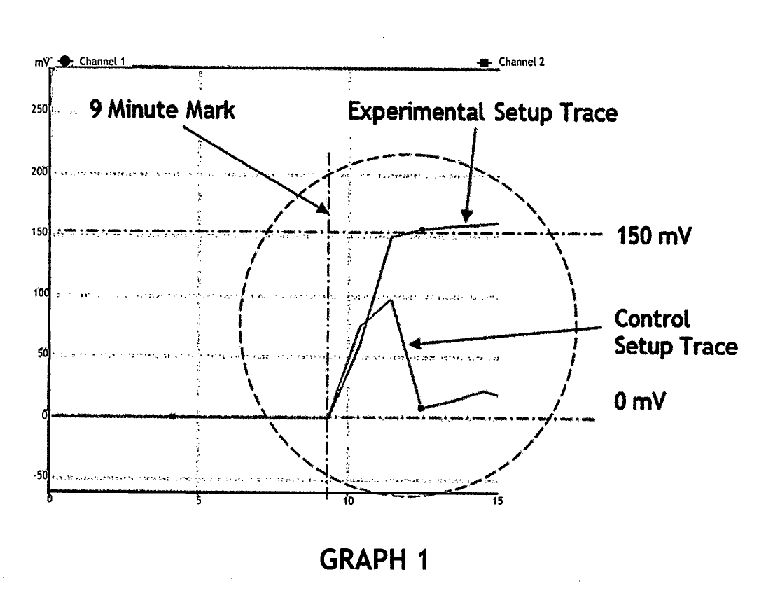

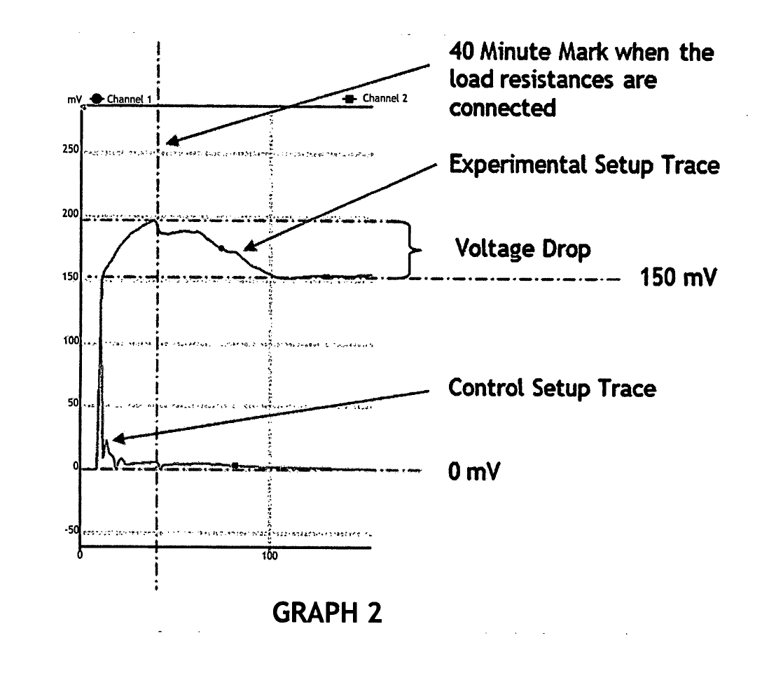

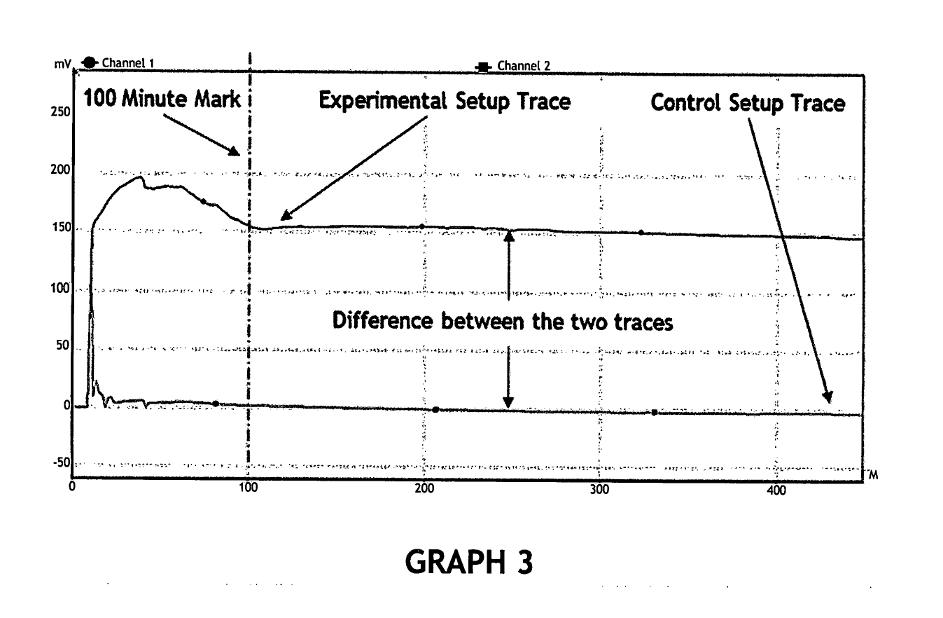

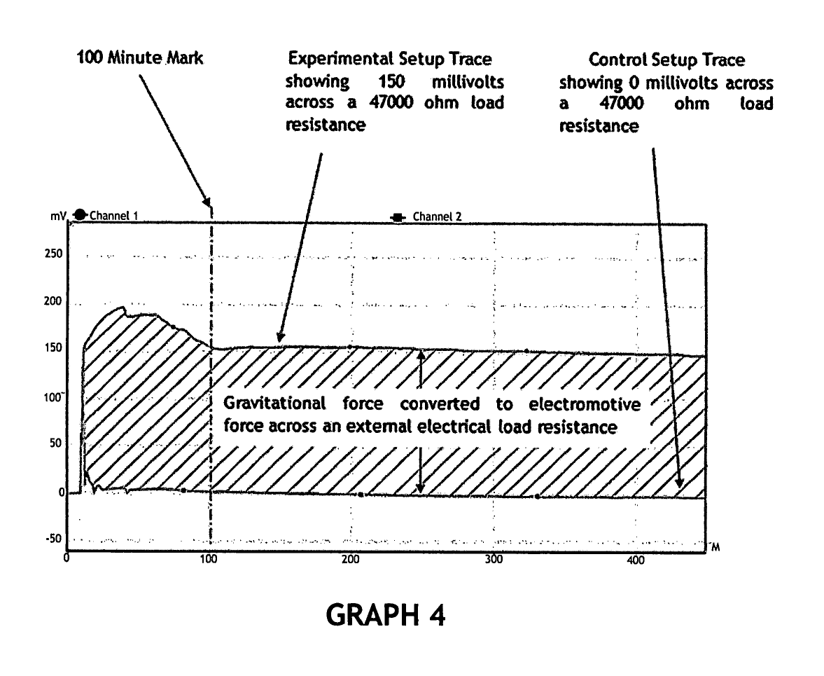

Referring now to FIG. 11, another preferred embodiment of the present invention 220′ is disclosed. The another preferred embodiment present invention 220′ comprises: a container 203, containing a more buoyant cation phase 204 and a less buoyant cation phase 206, a first electrode 202 immersed in the more buoyant cation phase 204 at the upper area of the container 203, a second electrode 205 immersed in the less buoyant cation phase 206 at the lower area of the container 203. The vertical portions of the electrodes 202 and 205 are insulated from the electrolyte by insulating jackets 207 and 208. Additionally, a voltage dependant variable load resistor ‘VDVR_{L}’ 216 having a resistance controlled by the computer via the driver and load ‘in circuit’/‘out of circuit’ switch S₁, S₁ may also be controlled by the computer; and millivoltmeter 201 electrically connected across electrodes 202 and 205 and interfaced with the computer, and a current meter 217 also interfaced with the computer 213.

Two identical electrically conductive electrodes 202 and 205 positioned in the cation phases 204 and 206. The vertical parts of said electrodes insulated from the electrolyte solution by insulating jackets 207 and 208, and means (not shown) to independently rise and lower electrode 202 and electrode 205 within said aqueous plural-electrolyte solution, and means (not shown) to secure and hold electrode 202 and electrode 205 in a stationary position relative to the two cation phases. The horizontal portion 210 of electrode 202 and the horizontal portion 211 of electrode 205 positioned in and exposed to the aqueous plural-electrolyte solution.

Electrodes are comprised of any electrically conductive material or any combination of electrically conductive materials. The physical composition of electrodes may include but not limited to smooth solid, abraded solid, wool, sponge or nano-particle composition of any electrically conductive material or of any combination of electrically conductive materials. The physical composition of electrodes may include but not limited to any combination of smooth solids, abraded solids, wools, sponges or nano-particles of any electrically conductive material or any combination of electrically conductive materials.

One or more catalytic agent may be used to increase the rate of oxidation and reduction. Some or all said catalytic agents may be part of the anode or the cathode or of both. Some or all said catalytic agents may be part of the more buoyant cation phase or of the less buoyant cation phase or of both. Some or all said catalytic agent may be part of the anode/electrolyte interface or the cathode/electrolyte interface or of both.

Millivoltmeter 201 is electrically connected across electrodes 202 and 205 and interfaced with the computer, and the current meter 217 is interfaced with the computer 213. The voltage dependant variable load resistor ‘VDVR_{L}’ 209 has a resistance that is controlled by the computer via the driver and load ‘in circuit’/‘out of circuit’ switch S₁. S₁ is deployed for open circuit voltage and loaded circuit voltage assays. The variable resistance of the VDVR_{L} can be set and held at various stationary resistances to assay a number of cell characteristics or can be continuously adjusted to assay other cell characteristics.

A personal computer 213 to record and assay the incoming data and make adjustments via the driver 212 to the voltage dependant variable load resistor, and a printer 214 and monitor display connected to the personal computer 213.

One of the many possible uses of preferred embodiments of the present invention is for detecting the amount of electrical energy produced by sample preferred embodiments comprising the steps of:
A. assaying sample embodiments of the present invention for an elevated level of produced electrical energy; and
B. correlating an elevated level of produced electrical energy of preferred embodiments of the present invention with their relative usefulness as sources of electrical energy.

The present invention discloses a method for converting gravitational force to electromotive force. None of the herein referenced prior art discloses a method for converting gravitational force to electromotive force. The conversion of gravitational force to electromotive force achieved by preferred embodiments of the present invention is seen as a significant departure from and an improvement over the prior art.

Preferred embodiments of the present invention utilize gravity to return the dissimilar species junction disparity between the anode phase of the first species and the reactant cation species phase back to its original condition or disparity, which is a significant departure from and a significant improvement over the prior art.

The electrodes utilized by preferred embodiments of the present invention are reusable, and the amount of electrode material in the system does not change. At such time as sufficient anode mass has been lost and sufficient cathode mass has been gained, the ability to simply reverse the relative positions of the two electrodes and continue generating electrical energy is seen as a significant departure from and an improvement over the prior art, however, the cell, cell body and the cation phases are not reversed or inverted,

By the above reasons and by other reasons disclosed herein, the preferred embodiments of the present invention are seen to be in a separate category apart from the concentration cell.

CONCLUSIONS: In physics and engineering, energy transformation or energy conversion is any process of transforming one form of energy to another. Energy of fossil fuels, solar radiation, or nuclear fuels can be converted into other energy forms such as electrical, propulsive, or heating that are more useful to us. Often, machines are used to transform energy. By the herein disclosed methods, preferred embodiments of the present invention are electrochemical machines that convert gravitational energy, energy associated with a gravitational field to electrical energy.

Throughout this specification, various patent and applications are referenced by application number and inventor. The disclosures of these patents and applications are hereby incorporated by reference in their entireties into this specification in order to more fully describe the state-of-the-art.

It is evident that many alternatives, modifications, and variations of the gravoltaic cells of the present invention are disclosed herein will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

2 Millivoltmeter
3 Load Switch
4 Load Resistance
10 Test Lead
11 Test Lead
12 Clear Vinyl Tube
17 Experimental U-Tube Setup
18 Manual Assaying and Correlating System
19 Electrochemical Impedance Spectroscopy (EIS)
25 Test Electrode
26 Reference Electrode
27 Test Reactant Cation Source
28 Reference Cation Source
29 Porous Cotton Barrier
102 Cathode of the First Species
103 Terminal B
105 Anode of the First Species
106 Terminal A
107 Nonconductive Reaction Vessel
109 Compartment of Cation Phase of the 2^{nd} Species
110 Compartment of Cation Phase of the 1^{st} species
111a Oxidizing Atoms of the 1^{st} Species
111b Migrating Cations of the 1^{st} Species
111c Reducing Cations of the 1^{st} Species
112 Equilibrated Cation Phases
114 Non-Conductive Ball Valve
115 Rubber Stopper
116 Rubber Stopper
120 Gravoltaic Cell
201 Millivoltmeter
202 Anode Electrode
203 Container
204 More buoyant cation phase
205 Cathode Electrode
206 less buoyant cation phase
207 and 208 Insulating Jackets
209 Variable Load Resistor
210 Horizontal Portion of Electrode 202
211 Horizontal Portion of Electrode 205
212 Driver
213 Personal Computer
214 Printer
216 Voltage Dependant Variable Load Resistor ‘Vdvrₗ’
217 Current Meter
220 Gravoltaic Cell
220′ Gravoltaic Cell
S₁ Load ‘In Circuit’/‘Out of Circuit’ Switch

I claim:

1. A method of creating a gravoltaic cell for converting a gravitational force into electrical energy, said method comprising:
providing a driving disparity between an anode phase of a first species and a reactant cation phase of a second species in contact with anode phase, said driving disparity is a disparity between an anode phase of a first species in contact with a reactant cation phase of a second species, an anode phase of said first species and a reactant cation phase of said second species separated in a same reaction vessel being a high potential energy situation in said reaction vessel, said system will attempt to lower potential energy by diffusing said two phases within said vessel into each other to form a uniform phase throughout, gravitational force, through an action of positive buoyancy or negative buoyancy causing a migration of newly oxidized and liberated cations of said first species away from said anode phase of said first species, thus allowing fresh reactant cations of the second species to again contact the anode phase of the first species sustaining the magnitude of said species disparity between the anode phase of the first species and the reactant cation phase of said second species; and
providing a electrochemically active anode junction-species disparity at a junction between an anode phase of said first species and a reactant cation species phase of a second species in contact with said anode phase, comprising an anode phase of said first species having a first placement and in contact with a first stationary homogeneous phase of dissociated aqueous cations of said reactant second cation species having a first placement, said first placement of said first stationary homogeneous phase of a reactant cation species phase of a second species being maintained by gravity by either negative buoyancy or positive buoyancy;
wherein said first placement of said stationary homogeneous phase of a reactant cation species phase of a second species occupying an upper compartment of said reaction vessel for negative buoyancy, and said first placement of said stationary homogeneous phase of a reactant cation species phase of a second species occupying said lower compartment of said reaction vessel for said positive buoyancy.

2. A method of creating a gravoltaic cell for converting a gravitational force into electrical energy, said method comprising:
a. providing two separately compartmentalized homogeneous stationary phases of aqueous dissociated electrolytic cations of at least two electrolytic species of at least one aqueous dissociated cation species per compartment, said at least two cation phases comprising at least one buoyant cation species phase and at least one non-buoyant cation species phase;
b. providing two separately compartmentalized homogeneous stationary phases of aqueous dissociated electrolytic cations of at least two electrolytic species of at least one aqueous dissociated cation species per compartment, said at least two cation phases comprising at least one reactant cation species phase and at least one reference cation species phase;
c. providing a gravitational field that sustains a separation of said at least two electrolytic species of at least one aqueous dissociated cation species per compartment into two compartments by their difference in relative buoyancy, said separation comprising a more buoyant phase of cation species being sustained at a first placement and a less buoyant phase of cation species being sustained at a second placement;
d. providing a stationary bulk phase of a homogeneous mixture of solvent and dissociated anions collectively disposed homogeneously throughout the entire reaction vessel and throughout the two said phases of dissociated aqueous cation phases;
e. providing two similar electrodes of the first species, a first electrode contacting said layer of reactant cation species phase of a second species and a second electrode contacting said layer of cation species phase of a first species;
f. providing migrating liberated cations of the first species, wherein atoms on a surface of said anode phase of the first species in contact with reactant cations of the second species oxidize and dissolve into the reactant cation species phase of a second species as migrating liberated aqueous cations of the first species, wherein the action of positive buoyancy or the action of negative buoyancy causes said liberated cations of the first species to migrate away from the surface of the anode phase of the first species, allowing fresh reactant cations of the reactant cation phase of the second species to contact said surface of said anode phase of the first species;
g. providing an external electrical load connected across said first and second electrodes for dissipating said electrical energy; and
h. holding the two said cation species phases and said first and second electrodes in stationary position relative to said gravitational field.

3. A method of creating a gravoltaic cell for converting a gravitational force into electrical energy, said method comprising:
a. providing a primary driving gravity-sustained electrochemical disparity between the electrochemical properties of an anode phase of a first species and the electrochemical properties of a stationary phase of dissociated aqueous reactant cations of a second species in immediate contact with the anode phase of the first species, said primary driving gravity-sustained electrochemical disparity being an electrochemical disparity at the junction between an anode phase of the first species and a stationary phase of dissociated aqueous reactant cations of said second species in immediate contact with the anode phase of the first species;
b. providing a primary driving gravity-sustained electrochemically active dissimilar anode/cation species junction having an anode phase of the first species in contact with a gravitationally-sustained compartmentalized homogeneous stationary phase of dissociated aqueous reactant cations of the second species, gravity sustaining but not initiating said compartmentalization, said primary driving junction generating relatively elevated electrode reactions, relatively elevated electrode potential, relatively elevated cell voltage, relatively elevated anode/cation junction current, relatively elevated current flow through an external load resistance, and relatively elevated electrical energy transferred to and dissipated by an external load resistance, compared to that of the electrochemically passive similar anode/electrolyte species junction of the concentration cell's relatively high internal cell resistance, diminished electrode reactions, diminished electrode potential, diminished cell voltage, diminished anode/cation junction current, diminished current flow through an external load resistance, and diminished electrical energy transferred to and dissipated by an external load resistance, said primary driving junction wherein, the anode phase of the first species being in contact with a gravitationally-sustained compartmentalized homogeneous stationary phase of dissociated aqueous reactant cations of the second species, and said gravitationally-sustained compartmentalization being sustained by the force of gravity;
c. providing a cathode phase of the first species in contact with a compartmentalized homogeneous stationary phase of dissociated aqueous reference cations of the first species, said anode phase and cathode phase having two electrically conductive similar materials;
d. providing two gravitationally separated and separately compartmentalized phases of dissociated cations comprising a gravitationally compartmentalized homogeneous stationary phase of dissociated aqueous reference cations of the first species, a gravitationally compartmentalized homogeneous stationary phase of dissociated aqueous reactant cations of the second species, a first compartmentalized homogeneous stationary phase of dissociated aqueous reference cations of the first species having a first density relative to a second compartmentalized homogeneous stationary phase of dissociated aqueous reactant cations of the second specie) having a second density, and a second (compartmentalized homogeneous stationary phase of dissociated aqueous reactant cations of the second species having a second density relative to a first (compartmentalized homogeneous stationary phase of dissociated aqueous reference cations of the first species) having a first density, the compartmentalized homogeneous stationary phase of dissociated aqueous reference cations of the first species having a first buoyancy relative to the compartmentalized homogeneous stationary phase of dissociated aqueous reactant cations of the second species having a second relative buoyancy, the compartmentalized homogeneous stationary phase of dissociated aqueous reactant cations of the second species having a second buoyancy relative to the compartmentalized homogeneous stationary phase of dissociated aqueous reference cations of the first species having a first buoyancy, the reference cations of the first species having a first buoyancy relative to the reactant cations of the second species having a second buoyancy, the reactant cations of the second species having a second buoyancy relative to the reference cations of the first species having a first buoyancy, wherein the more buoyant phase of dissociated aqueous cations tend to occupy, in whole or in part, the upper compartment of the cell, while the less buoyant dissociated cations tend to occupy, in whole or in part, the lower compartment of the cell;
e. providing a method that when sufficient mass has been transferred from the anode to the cathode, as the anode loses mass through erosion (oxidation) and the cathode gains mass through electroplating (reduction), the two electrodes are interchanged; however, the reaction vessel, the stationary homogeneous phase of solvent and dissociated anions, and the two stationary homogeneous phases of dissociated aqueous cations are not interchanged, wherein the interchanging of the two electrodes renews the electrodes but does not renew the energy of the system;
f. providing a gravitational field that extends into said second stationary phase of dissociated aqueous reactant cations of the second species and first stationary phase of dissociated aqueous reference cations of the first species and that sustains the compartmentalization of said two stationary phases of dissociated aqueous cation wherein the stationary phase of the more buoyant cations tend to occupy, in whole or in part, a upper compartment of the cell, and the stationary phase of less buoyant cations tend to occupy, in whole or in part, a lower compartment of the cell, wherein said gravitationally-sustained compartmentalization being sustained by the force of gravity;
g. providing an external electrical load resistance connected to the output terminals of the anode and cathode for dissipating the electrical energy generated; and
h. providing an assaying and correlating system including a load resistance switch, and a variable load resistance, connected to the gravity-sustained electrochemically active dissimilar anode/cation species junction gravoltaic cell.

4. The method of claim 3, wherein said data logger is attached to a computer with appropriate software applications.

5. The method of claim 3, wherein said gravitationally-sustained compartmentalization is initiated by manmade manufactured means.

6. The method of claim 3, wherein said anode phase of said first species is in contact with a gravitationally-sustained manufactured compartmentalized stationary cation phase of the second species.

7. A method of creating a gravoltaic cell for converting a gravitational force into electrical energy, said method comprising:
a. providing a primary driving gravity-sustained electrochemical disparity between the electrochemical properties of an anode phase of a first species and the electrochemical properties of a stationary phase of dissociated aqueous reactant cations of a second species in immediate contact with the anode phase of the first species, said primary driving gravity-sustained electrochemical disparity being an electrochemical disparity at the junction between an anode phase of the first species and a stationary phase of dissociated aqueous reactant cations of said second species in immediate contact with the anode phase of the first species;
b. providing a primary driving gravity-sustained electrochemically active dissimilar anode/cation species junction having an anode phase of the first species in contact with a gravitationally-sustained compartmentalization of a stationary phase of dissociated aqueous reactant cations of the second species, gravity sustaining but not initiating said compartmentalization, said primary driving junction generating relatively elevated electrode reactions, relatively elevated electrode potential, relatively elevated cell voltage, relatively elevated anode/cation junction current, relatively elevated current flow through an external load resistance, and relatively elevated electrical energy transferred to and dissipated by an external load resistance, compared to that of the electrochemically passive similar anode/electrolyte species junction of the concentration cell's relatively high internal cell resistance of the concentration cell, diminished electrode reactions, diminished electrode potential, diminished cell voltage, diminished anode/cation junction current, diminished current flow through an external load resistance, and diminished electrical energy transferred to and dissipated by an external load resistance, said primary driving junction wherein, the anode phase of the first species being in contact with a gravitationally-sustained compartmentalized stationary phase of dissociated aqueous reactant cations of the second species, and said gravitationally-sustained compartmentalization being sustained by the force of gravity;
c. providing a cathode of the first species in contact with a gravitationally-sustained compartmentalized stationary phase of dissociated aqueous reference cations of the first species, said anode phase and cathode phase having two electrically conductive similar materials;
d. providing two gravitationally compartmentalized and stationary aqueous phases of dissociated cations comprising a gravitationally compartmentalized stationary phase of dissociated aqueous reference cations of the first species, a gravitationally compartmentalized stationary phase of dissociated aqueous reactant cations of the second species, a first stationary phase of dissociated aqueous reference cations of the first species having a first density relative to a second stationary phase of dissociated aqueous reactant cations of the second species having a second density, and a second stationary phase of dissociated aqueous reactant cations of the second species having a second density relative to a first stationary phase of dissociated aqueous reference cations of the first species having a first density, the stationary phase of dissociated aqueous reference cations of the first species having a first buoyancy relative to the stationary phase of dissociated aqueous reactant cations of the second species having a second relative buoyancy, the stationary phase of dissociated aqueous reactant cations of the second species having a second buoyancy relative to the stationary phase of dissociated aqueous reference cations of the first species having a first buoyancy, the reference cations of the first species having a first buoyancy relative to the reactant cations of the second species having a second buoyancy, the reactant cations of the second species having a second buoyancy relative to the reference cations of the first species having a first buoyancy, wherein the more buoyant phase of dissociated aqueous cations tend to occupy, in whole or in part, an upper compartment of the gravoltaic cell, while less buoyant dissociated cations tend to occupy, in whole or in part, a lower compartment of the gravoltaic cell;
e. providing a method that when sufficient mass has been transferred from the anode phase to the cathode phase, as the anode phase loses mass through erosion or oxidation and the cathode phase gains mass through electroplating or reduction, the two electrodes are interchanged; the reaction vessel, the stationary homogeneous phase of solvent and dissociated anions, and the two stationary homogeneous phases of dissociated aqueous cations not being interchanged, wherein the interchanging of the two electrodes renews the electrodes but does not renew the energy of the system;
f. providing a gravitational field that extends into said second stationary phase of dissociated aqueous reactant cations of the second species and first stationary phase of dissociated aqueous reference cations of the first species and that sustains a compartmentalization of said two stationary phases of dissociated aqueous cation wherein the stationary phase of the more buoyant cations tend to occupy, in whole or in part, an upper compartment of the cell, and the stationary phase of less buoyant cations tend to occupy, in whole or in part, a lower compartment of the cell, wherein said gravitationally-sustained compartmentalization being sustained by the force of gravity;
g. providing an external electrical load resistance connected to the output terminals of the anode and cathode for dissipating the electrical energy generated; and
h. providing a computerized assaying and correlating system including a data logger connected to the gravity-sustained electrochemically active dissimilar anode/cation species junction gravoltaic cell.

8. The method of claim 7, wherein said data logger is attached to a computer with appropriate software applications.

9. The method of claim 7, wherein said gravitationally-sustained compartmentalization is initiated by manmade manufactured means.

10. The method of claim 7, wherein said anode phase of said first species is in contact with a gravitationally-sustained manufactured compartmentalization of a stationary phase.

11. A gravoltaic cell for converting a gravitational force into electrical energy, said gravoltaic cell comprising:
a. a reaction vessel;
b. a first stationary homogeneous phase of dissociated aqueous cations having dissociated aqueous cations of a first species and a second stationary homogeneous aqueous phase of dissociated aqueous reactant cations having dissociated aqueous cations of a second species, both said two distinct stationary homogeneous phases of dissociated aqueous cations being disposed within said reaction vessel, and providing bulk solvent and anions a stationary bulk phase of a homogeneous mixture of solvent and dissociated anions collectively disposed homogeneously throughout the two said phases of dissociated aqueous cations; and
c. an anode junction providing electrochemically active dissimilar anode/cation species junction comprising an anode phase of the first species having a first placement in contact with a gravity-sustained stationary homogeneous phase of dissociated aqueous reactant cations of the second species having a first placement, and a cathode junction providing a gravity-sustained electrochemically passive similar cathode/cation species junction comprising a cathode of the first species having a second placement in contact with a gravity-sustained stationary homogeneous phase of dissociated aqueous reference cations of the first species having a second placement;
wherein a buoyancy separation is gravitationally sustained between two distinct stationary homogeneous phases of dissociated aqueous cations differing chemically in species and differing physically in buoyancy disposed within a homogeneous stationary bulk mixture of solvent and dissociated anions disposed within the reaction vessel, one said distinct stationary homogeneous phase of dissociated aqueous cations having a greater relative buoyancy and the other said distinct stationary homogeneous phase of dissociated aqueous cations having a lesser relative buoyancy, both said two distinct stationary homogeneous phases of dissociated aqueous cations are held separate and stationary by their difference in relative buoyancy.
